(19) United States
(12) Patent Application Publication
(10) Pub. No.: US 2026/0261629 A1
(43) Pub. Date: Sep. 3, 2026

(54) VIRTUALIZATION OF SENSORS FOR A MULTI-PARTICIPANT INTERACTIVE SESSION

(71) Applicant: Looq Sensing Technologies Ltd., Kadima (IL)

(72) Inventors: Guy LAVI, Kadima (IL); Adi SHEINFELD, Durham, NC (US); Adi DAFNI, Givat Brenner (IL); Asaf SHIMSHOVITZ, Rehovot (IL); Hila BLECHER SEGEV, Ramat Yishai (IL); Adiel ABILEAH, Portland, OR (US)

(73) Assignee: Looq Sensing Technologies Ltd., Kadima (IL)

(21) Appl. No.: 18/875,318

(22) PCT Filed: Jun. 14, 2023
(86) PCT No.: PCT/IL2023/050614

§ 371 Date: Dec. 16, 2024

Related U.S. Application Data
(60) Provisional application No. 63/352,683, filed on Jun. 16, 2022.

(51) Int. Cl. H04N 7/15; G06N 3/0455; G06T 7/20; G06T 7/50; G06T 7/70

(52) U.S. Cl. CPC H04N 7/157; G06N 3/0455; G06T 7/20; G06T 7/50; G06T 7/70; H04N 7/152

(57) ABSTRACT

There is provided a method, comprising: defining a virtual sensor on a sensor array on a common surface, analyzing sensor datasets of the sensor array depicting an object from different views, computing a virtual sensor dataset for the virtual sensor, and directing a stream of the virtual sensor dataset to a client terminal, for depicting the object as viewed from the virtual sensor. Optionally, the common surface comprises a display, and an image of a user is presented on the display. In iterations: tracking motion of the user across the display to identify a new location of the user on the display, selecting a new location of the virtual sensor on the display according to the new location of the user on the display, computing the virtual sensor dataset for the new location of the virtual sensor, and directing the stream of the virtual sensor dataset to the client terminal.

### RELATED APPLICATION

This application claims the benefit of priority of U.S. Provisional Patent Application No. 63/352,683 filed on Jun. 16, 2022, the contents of which are incorporated herein by reference in their entirety.

### FIELD AND BACKGROUND OF THE INVENTION

The present invention, in some embodiments thereof, relates to remote interaction sessions and, more specifically, but not exclusively, to systems and methods for improving a user experience in remote interaction

Remote interaction sessions between participants have become common, in particular after COVID-19 in which many people switched to working from home. In such interaction sessions, two or more participants join a virtual conference, in which each person is able to see and hear all of the other participants by receiving data captured by cameras and microphones at each of the remote locations of the participants.

Other types of interactions are virtual, for example, a user may wear a virtual reality (VR) headset, and navigate within a virtual world.

### SUMMARY OF THE INVENTION

According to a first aspect, a computer implemented method of virtualization of one or more sensors, comprises: defining a location of a virtual sensor on a sensor array disposed on a common surface, analyzing a plurality of sensor datasets of the sensor array captured from a plurality of different views, computing a virtual sensor dataset for the location of the virtual sensor according to the analysis, and directing a stream of the virtual sensor dataset to a client terminal.

According to a second aspect, a system for virtualization of one or more sensors for interactions between participants participating in a virtual conference, comprising: at least one processor executing a code for: defining a virtual sensor on a sensor array disposed on a common surface, analyzing a plurality of sensor datasets of the sensor array captured from a plurality of different views, computing a virtual sensor dataset for the virtual sensor according to the analysis, and directing a stream of the virtual sensor dataset to a client terminal.

According to a third aspect, a method of training a generative adversarial network (GAN) for synthesis of a virtual image of a participant participating in a conference, comprises: generating a multi-record training dataset, wherein a record comprises: a plurality of sensor datasets depicting different views of the participant captured by a plurality of sensors disposed on a common surface, and a ground truth view of the participant captured by a ground truth sensor, training the GAN for generating a virtual sensor dataset corresponding to a virtual sensor in response to an input of a plurality of sensor datasets captured by a plurality of sensors of the common surface, wherein a generating component is adapted during training on feedback from a discriminator component for generating virtual sensor datasets that the discriminator component cannot accurately distinguish from ground truth.

In a further implementation of the first and second aspects, the common surface comprises a display, and further comprising: presenting an image of a user on the display, in at least one iteration: dynamically tracking motion of the user across the display to identify a new location of the user on the display, dynamically selecting a new location of the virtual sensor on the display according to the new location of the user on the display, computing the virtual sensor dataset for the new location of the virtual sensor, and directing the stream of the virtual sensor dataset to the client terminal.

In a further implementation of the first and second aspects, dynamically tracking motion of the user across the display comprises analyzing an image depicting the user on the display to identify motion of the user within the image.

In a further implementation of the first and second aspects, the image of the user is presented within a window on the display, and dynamically tracking motion of the user across the display comprises tracking change of location of the window on the display.

In a further implementation of the first and second aspects, the image of the user presented on the display is captured by a camera remotely located in proximity to the client terminal and in proximity to the user, wherein the user is viewing the client terminal while the camera is capturing images of the user.

In a further implementation of the first and second aspects, the camera is selected from: another virtual sensor located on another common surface created from another sensor array capturing images of the user, and a standard camera capturing a video.

In a further implementation of the first and second aspects, the virtual sensor, the virtual sensor dataset, the sensor datasets, and the sensor array are selected from a group comprising: (i) a virtual video camera, a virtual video, captured videos, and physical video camera, and (ii) a virtual audio track, a virtual microphone, captured audio tracks, and physical microphones.

In a further implementation of the first and second aspects, the virtualization of the one or more sensors is for interactions between participants participating in a virtual conference, wherein the virtual sensor is selected for generating a single face-on view of a first participant as seen remotely by at least one second participant participating in a conference, wherein the plurality of sensor datasets of the sensor array capture the first participant from the plurality of different views, and wherein the client terminal is of the at least one second participant, for depicting a single face-on view of the first participant as viewed from the virtual sensor by the second participant.

In a further implementation of the first and second aspects, a plurality of participants are participating in the conference, wherein the plurality of participants include the first participant associated with a certain sensor array, and a plurality of second participants remotely interacting with the first participant via the conference, for the plurality of participants: defining comprises defining a plurality of virtual sensors, each one of the plurality of virtual sensors representing a respective face-on view from one of the plurality of second participants viewing the first participant, computing comprises computing a plurality of virtual sensor datasets for the plurality of virtual sensors according to the analysis, and feeding comprises feeding a plurality of streams of the plurality of virtual sensor datasets from the sensor array of the first participant to the plurality of sensor arrays of the plurality of second participants.

In a further implementation of the first and second aspects, further comprising: defining a virtual seating arrangement for the plurality of participants participating in the conference, and for each sensor array of each of the plurality of participants, defining locations of the plurality of virtual sensors on the sensor array according to the virtual seating arrangement, and mapping the plurality of virtual sensors at the defined locations to the plurality of second participants according to the defined virtual seating.

In a further implementation of the first and second aspects, the virtual seating arrangement defines a relative location of each of the plurality of participants, each sensor array is associated with a display, a presentation of each of the plurality of participants is located on the display in an order corresponding to the virtual seating arrangement, wherein each virtual sensor corresponding to each participant is virtually positioned at each presentation on the display.

In a further implementation of the first and second aspects, directing comprises: assigning a destination address to each of the plurality of streams of each of the plurality of sensor arrays of each of the plurality of participants, the destination address indicating the respective second participant associated with the respective virtual sensor of the respective sensor array, and routing each stream associated according to the destination address for presentation on a client device of the second participant.

In a further implementation of the first and second aspects, the plurality of streams of the plurality of sensor arrays of each of the plurality of participants are transmitted to a central server that maps and forwards the plurality of streams to a plurality of destinations of a plurality of client terminals of the plurality of second participants.

In a further implementation of the first and second aspects, analyzing comprises feeding the plurality of sensor datasets into a virtualization machine learning model that generates the virtual sensor dataset as an outcome thereof.

In a further implementation of the first and second aspects, the virtualization machine learning model comprises a generative adversarial network comprising a generator component and a discriminator component, wherein the generator component generates an outcome of virtual sensor dataset corresponding to a virtual sensor in response to an input of a plurality of sensor datasets captured by a plurality of sensors, wherein the generating component is adapted during training on feedback from the discriminator component for generating virtual sensor datasets that the discriminator component cannot accurately distinguish from ground truth datasets captured by a ground truth sensor.

In a further implementation of the first and second aspects, the generator component is trained on a training dataset of a plurality of records, each record including a plurality of sample sensor datasets depicting a plurality of different views, and a ground truth dataset depicting a ground truth view of a ground truth sensor representing the virtual sensor.

In a further implementation of the first and second aspects, the plurality of sample sensor datasets of the record include a plurality of sample time synchronized sensor datasets, and the ground truth dataset includes a ground truth time synchronized sensor dataset.

In a further implementation of the first and second aspects, the plurality of sample sensor datasets of the record include a plurality sample videos including sequentially captured frames, and the ground truth dataset includes a ground truth video including sequentially captured frames, wherein the plurality of sample videos and the ground truth video are simultaneously captured, and stored in the record in a time synchronized manner.

In a further implementation of the first and second aspects, the training dataset includes a plurality of locations for each of the plurality of sample sensor datasets, a ground truth location for the ground truth view, wherein the generator component is trained for generating the virtual sensor view at a target location in response to an input of the target location and the plurality of sample sensor datasets.

In a further implementation of the first and second aspects, the generator component is dynamically updated during a virtual conference, wherein the training dataset is dynamically created during the virtual conference by selecting at least one of the plurality of sample sensor datasets as the ground truth view, and setting the other plurality of sample sensor datasets that are not selected as the ground truth view as sample inputs of the record.

In a further implementation of the first and second aspects, each sensor of the sensor array is configured for outputting a compromised quality dataset depicting a partial field of view, and computing the virtual sensor dataset comprises stitching a plurality of compromised quality datasets into a main dataset at higher quality that depicts a full field of view.

In a further implementation of the first and second aspects, computing comprises feeding the plurality of compromised quality datasets into a stitching ML model that generates the main dataset as an outcome thereof, the stitching ML model trained on a stitching training dataset comprising a plurality of records, each record including a sample of a plurality of compromised quality datasets and a ground truth main dataset obtained from at least one of: a high quality sensor and a synthesized dataset.

In a further implementation of the first and second aspects, each compromised quality dataset of each sensor is fed an autoencoder that extracts an encoding, a plurality of the encodings are of a plurality of the autoencoders are fed into the stitching ML model, wherein the stitching ML model and the plurality of autoencoders are jointly trained end to end.

In a further implementation of the first and second aspects, the virtual sensor dataset includes a depth map indicating a respective depth for each data element of the virtual sensor dataset relative to a normal at a location of the virtual sensor.

In a further implementation of the first and second aspects, the depth map is computed by feeding the plurality of sensor datasets into a depth ML model trained on a depth training dataset comprising a plurality of records, each record including a plurality of sample sensor datasets and a ground truth of a sample depth map.

In a further implementation of the first and second aspects, at least one record includes a plurality of sample sensor datasets and the ground truth produced synthetically from a 3D simulation.

In a further implementation of the first and second aspects, further comprising merging the plurality of sensor datasets into a lattice in which each sensor dataset is positioned based on location in space of the corresponding sensor, wherein the lattice represents a single dataset in which relative location of each sensor is defined, and converting a plurality of positions of the lattice into indications of depth relative to the virtual sensor for computing the depth map for the virtual sensor dataset.

In a further implementation of the first and second aspects, the sensor array comprises a plurality of sensors selected from a group comprising imaging sensors and audio sensors.

In a further implementation of the first and second aspects, the common surface comprises a display, and wherein the sensor array comprises a plurality of imaging sensors arranged in a grid located behind and/or within the screen, the plurality of imaging sensors being spaced part and distributed across a width and length of the screen, wherein a plurality of pixels are disposed between spaced apart imaging sensors.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for virtualizing sensors for interactions between participants in a virtual conference, in accordance with some embodiments of the present invention;

FIG. 2 is a flowchart of a method for virtualizing sensors for interactions between participants in a virtual conference, in accordance with some embodiments of the present invention;

FIG. 3 is a schematic depicting physical sensors and virtual sensors on a common surface, in accordance with some embodiments of the present invention;

FIG. 4 is a schematic depicting selection of virtual sensors according to defined positions of participants participating in a virtual conference, in accordance with some embodiments of the present invention;

FIG. 5 is a schematic depicting exemplary videos generated for different participants according to virtual sensors, in accordance with some embodiments of the present invention;

FIG. 6 is a schematic depicting an experiment performed by Inventors for evaluation of embodiments described herein;

FIG. 7 is a schematic depicting another experiment performed by Inventors for evaluation of embodiments described herein;

FIG. 8 is an exemplary dataflow of training neural networks for processing inputs from sensors, in accordance with some embodiments of the present invention;

FIG. 9 is an exemplary dataflow of training an autoencoder for converting low quality input obtained from one or more sensors into high quality output, in accordance with some embodiments of the present invention;

FIG. 10A is a flowchart of an exemplary flow of dynamically selecting a virtual sensor, in accordance with some embodiments of the present invention;

FIG. 10B is a flowchart of another exemplary flow of dynamically selecting a virtual sensor, in accordance with some embodiments of the present invention;

FIG. 11 is a schematic of an exemplary GAN for generating output of a virtual sensor, in accordance with some embodiments of the present invention;

FIG. 12 is a flowchart of an exemplary method for training the GAN for generating a virtual sensor dataset of a virtual sensor in response to an input of multiple sensor datasets of real sensors on a common surface, in accordance with some embodiments of the present invention; and

FIG. 13 is a schematic of an exemplary setup for providing an immersive experience without headset and/or other active engagement with a user interface, in accordance with some embodiment of the present invention.

### DESCRIPTION OF SPECIFIC EMBODIMENTS OF THE INVENTION

The present invention, in some embodiments thereof, relates to remote interaction sessions and, more specifically, but not exclusively, to systems and methods for improving a user experience in remote interaction.

An aspect of some embodiments of the present invention relates to systems, methods, computing devices, and code (stored on a memory) for virtualization of one or more sensors, for example, for interactions between participants in a virtual conference, and/or for virtual viewing of an object such as another human (e.g., participant) and/or inanimate objects. A virtual sensor is defined on a sensor array disposed on a common surface. The location of the virtual sensor may be selected, for example, for generating a single face-on view of a first participant as seen remotely by a second participant participating in a conference, dynamically according to location of the first participant and/or the second participant, dynamically according to location of an object viewed by a user, and/or by the user. Multiple sensor datasets of the sensor array are analyzed. The sensor datasets depict the first participant and/or object from a plurality of different views. A virtual sensor dataset is computed for the virtual sensor location according to the analysis. A stream of the virtual sensor dataset is directed to a client terminal, for example, for presentation on a display. The client terminal is of at least one second participant and/or of a user. The stream may depict a single face-on view of the first participant as viewed from the virtual sensor by the second participant. The stream may depict a target pose of the object as viewed from the virtual sensor by the user.

The term user and second participant are used interchangeably.

The term first participant and object may be used interchangeably.

The sensors, virtual sensors, and stream may be of video and/or audio. Embodiments described herein with respect to video may be adapted for audio. For example, to create a virtual audio sensor that streams audio data heard from a certain location defined by the location of the virtual audio sensor.

The analysis may be performed by feeding the sensor datasets into a trained generative adversarial network (GAN). The virtual sensor dataset may be obtained as outcome of the GAN.

In at least some embodiments described herein, the GAN does not necessarily synthesize the virtual sensor dataset according to standard approaches where a GAN is used to synthesize a fake image. Rather, in at least some embodiments, the GAN is used to complement multi-view triangulation to ensure the resulting stream has reduced artifacts (e.g., is flaw-less, or reduced flaws) in comparison to not using the GAN. In other words, the GAN does not fully synthesize the virtual sensor dataset, but rather corrects views from physical sensors, depicting the real life objects and/or people captured by the physical sensors. This is contrast to standard uses of GANs to synthesize a completely fake image that does not exist in real life, and is not depicted in any images fed into the GAN.

An aspect of some embodiments of the present invention relates to systems, methods, computing devices, and code (stored on a memory) for training a GAN for synthesis of a virtual image of a participant participating in a conference, comprises: generating a multi-record training dataset, wherein a record comprises: a plurality of sensor datasets depicting different views of the participant captured by a plurality of sensors disposed on a common surface, and a ground truth view of the participant captured by a ground truth sensor, training the GAN for generating a virtual sensor dataset corresponding to a location of a virtual sensor in response to an input of a plurality of sensor datasets captured by a plurality of sensors of the common surface, wherein a generating component is adapted during training on feedback from a discriminator component for generating virtual sensor datasets that the discriminator component cannot accurately distinguish from ground truth.

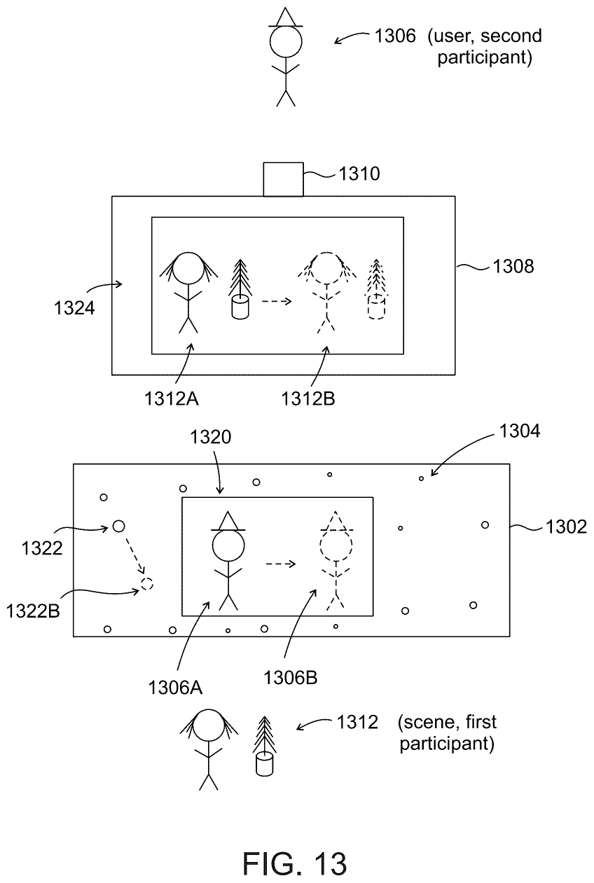

Optionally, the following setup, as described below in detail with reference to FIG. 13, is used—the common surface is implemented as a display, with the sensor array embedded within display. A user is located remotely viewing the images on the client terminal. A camera located remotely in proximity to the client terminal captures images of the user, and sends the images for presentation on the display. The camera may be another virtual sensor located on another common surface created from another sensor array capturing images of the user, or a standard camera capturing a video. A first participant or other scenery (e.g., baseball game, concert, safari) may be located in proximity to the common surface, in which case the user in proximity to the display is the second participant. The stream of the virtual sensor dataset depicting the first participant, is streamed from the common surface (e.g., display) to the client terminal, for viewing by the second participant.

The following features may be iterated in one or more iterations. Motion of the user across the display is dynamically tracked to identify a new location of the user on the display. The motion of the user across the display may be tracked by analyzing the image of the user presented on the display to detect movement of the user. For example, when the user physically changes their position such as moving their body to the left, the physical change is depicted as movement to the left in the image on the display. Alternatively or additionally, the image of the user may be presented within a window on the display, for example, within a user interface (GUI) that presents different participants in a conference call. The window of the image of the user may be moved to a different location on the display, for example, by the first participant located in front of the display, and/or by automatically by code. The new location on the display is tracked. In response to the new location of the user on the display, a new location of the virtual sensor on the display is selected. The virtual sensor dataset is computed for the new location of the virtual sensor. The stream of the virtual sensor dataset is directed to the client terminal. This process may generate a virtual immersive experience for the user, that does not require a headset and/or other active interface action by the user (e.g., joystick). The image presented on the display of the client terminal is dynamically adapted to different views according to physical location changes of the user viewing the client terminal, without requiring active engagement of the user with a physical user interface such as headset and/or joystick.

Approaches described herein with respect to video may be implemented with respect to audio.

At least some of the displays, devices, systems, methods, and code instructions (stored on a memory for execution by a processor) described herein address the technical problem of improving interactions between participants of a virtual conference, where the participants see one another via remotely located cameras and/or hear one another via remotely located microphones. In such virtual conferences, gaze of individuals, and/or direction of voice between individuals, which is an important components of real world human interaction, is meaningless, uninformative, incorrect, or entirely lost. Traditionally, people would sit around a table for a discussion. A person speaking would look at one or more of the other participants. Those listening would look at the person speaking, or at other participants. Similarly, the voices of the participant is directed towards one or more other participants. Those listening may be aware that the voice of the participant is directed towards one or more specific participants. In a virtual conference, cameras capture each person as they look at their screen. However, since the order of images of the remotely attending participants may be random and/or not different on each display, the gaze and/or audio direction of each participant looking at their screen as captured by the camera and/or microphone is irrelevant to the discussion. For example, when two people are speaking to each other over the virtual conference, no mechanism exists to help them gaze at one another and/or direct speech at one another during the discussion. Camera may capture them looking away, when in fact they are looking at the image of the other person on their screen. A microphone may generally capture speech without providing any indication of direction towards where the speech is aimed.

At least some of the displays, devices, systems, methods, and code instructions described herein improve the technology of remote virtual conferences, by enabling a gaze experience between participants in the virtual conference, similar to the gaze that would be experienced if the same participants were sitting together around a table. The gaze improves the interaction between participants in the virtual conference, which may improve communication between the users, by introduction of the non-verbal dimension of human communication into virtual conferences.

At least some of the displays, devices, systems, methods, and code instructions described herein improve the technology of remote virtual conferences, by enabling an audio experience between participants in the virtual conference, similar to the audio experience that would be experienced if the same participants were sitting together around a table. The direction of audio improves the interaction between participants in the virtual conference, which may improve communication between the users, by introduction of the non-verbal dimension of human communication into virtual conferences, for example, helping users better understand who is speaking to who.

At least some implementations described herein provide a solution to the above mentioned technical problem and/or improve the above mentioned technology, by defining a virtual seating order for the participants in the conference, and defining virtual sensors on a sensor array of a common surface, for example, a display with multiple cameras and/or multiple microphones and/or speakers. Each display may present images of the other participants according to the virtual seating order. A virtual sensor is defined for each of the other participants, at a location corresponding to where their image is presented on the display. A virtual sensor dataset, optionally a virtual video dataset and/or virtual audio dataset, is created for each virtual sensor (e.g., virtual camera, virtual microphone, virtual speakers) from the images captured by the cameras in the display and/or audio signal captured by microphones in the display. Each virtual sensor dataset is streamed for presentation and/or audio play on a display of the corresponding participant. The virtual sensor dataset depicts a view as would be seen by the corresponding participant on the corresponding location of the display, and/or as would be heard by the corresponding participant from the corresponding location of the display. This enables, for example, two participants to gaze at each other via the display while speaking, while other participants watching the two participants are able to discern that they are gazing at one another and/or speaking to one another. The gaze and/or direction of speech of each participant towards another participant is apparent as if the participants were sitting together around a table and gazing and/or speaking towards each other in the same room.

At least some of the displays, devices, systems, methods, and code instructions described herein address the technical problem of providing a virtual immersive experience without necessarily requiring active interaction with an interface, for example, without a headset, joystick, and/or avatar. At least some of the displays, devices, systems, methods, and code instructions described herein improve the technology of virtualization, by providing a virtual immersive experience without necessarily requiring active interaction with an interface, for example, without a headset, joystick, and/or avatar. At least some of the displays, devices, systems, methods, and code instructions described herein improve upon previous approaches for virtualization. Other approaches are based on active interaction with an interface, for example, without a headset, joystick, and/or avatar. At least some implementations described herein do not necessarily require active interaction with the interface.

At least some of the displays, devices, systems, methods, and code instructions described herein provide a solution to the aforementioned technical problem, and/or improve the aforementioned technical field, and/or improve upon aforementioned approaches, by dynamically changing the location of a virtual sensor on a sensor array disposed on a common surface, optionally a display. The location of the virtual sensor on the common surface is dynamically adapted in response to dynamic tracking of a location of a user on the display. The dynamically changing location of the virtual sensor dynamically changes the view captured by the virtual sensor, which is streamed for presentation on a client terminal being viewed by the user. This provides an immersive experience for the user, without requiring active engagement with a physical interface such as headset of joystick, since the view of the remote scene (e.g., first participant, concert, sports game) presented on the display viewed by the user is dynamically adapted according to changing locations of the user.

The approach described herein that dynamically adapts the location of the virtual sensor for dynamically generating a different virtual dataset based on data captured by the sensor array, i.e., direct multi-sensor to virtual sensor smart interpolation, is different than other approaches that render and/or reconstruct a 3D image from multiple different 2D images. The virtual sensor may represent 2D images, similar to images captured by other sensors of the array, at locations where no sensor actually exists. 3D images are not necessarily created.

At least some of the displays, devices, systems, methods, and code instructions described herein provide a solution to the aforementioned technical problem, and/or improve the aforementioned technical field, and/or improve upon aforementioned approaches, by multiple sensors embedded in a common surface (e.g., display), that enable to capture the scene from multiple and different views. Each sensor captures a live video stream of each of the users and/or objects, and the scene view. The fusion of multiple sensors input allows for a wide scene view and/or reconstruction of the scene and optionally each of the users and objects in the scene from a selected virtual sensor which is located where no corresponding real physical sensor exists. The ability to view the scene from multiple different views and/or a wide angle enables the user to engage with the scene similar to a real-life experience. As part of this experience, the user may interact with the screen as freely as needed. For example, the user may zoom in on another person, a counterpart, and/or a specific spot in the scene. The user may zoom out and/or scroll up and/or down as desired. This kind of interaction creates a feeling of real-life presence within the scene.

At least some embodiments described herein provide a user immersive experience without using a headset (and/or other active user interface such as joystick) that is enabled using multiple sensor inputs and a core processing pipeline, as described herein. With the sensor inputs, a trained machine learning model, optionally GAN, may predict and/or output any virtual sensor on the common surface (e.g., screen). This virtual sensor output may be streamed in real-time to the client side like in the case of a physical sensor. This kind of freedom allows for as dense as needed grid of virtual sensors that create the desired immersive experience with no need for any real physical sensor at that point of interest.

The immersive experience described herein (without headset and/or other active user interface such as joystick) may include the dynamic adaptation of the location of the virtual sensor, which dynamically adapts the virtual sensor dataset that is provided and/or presented.

At least some embodiments described herein provide a user immersive experience that is different from other virtual reality (VR) immersive experiences. The immersive experience based on embodiments described herein is limited to the field of view of the sensor array on the common surface. Both the physical sensors and virtual sensors may have a limited field of view that is defined, for example, by the physical sensor's manufacturer. The fused view may not necessarily exceed this limit, meaning that the virtual sensor may (e.g., only) capture the scene that is in front and/or sides of the common surface with sensor array, but not necessarily in the back of it.

Another difference to note over other approaches is the user's appearance. Based on embodiments described herein, the user will not be necessarily represented by an avatar but rather by a standard natural video stream of the user and the scene. This video stream may include multi-view and zoom capabilities, as described herein.

The immersive experience provided by at least some embodiments described herein may relate to one or more of the following features:
Remote users may view the scene from multiple different views, optionally dynamically adapted. For example, a small amount of those views are outputs of real physical sensors, and most views may be outputs of virtual sensors.
Enables the complete VR experience, the ability to virtually move around the scene and view all aspects of it in a continuous manner with no need for a headset and/or a joystick (and/or other active user interface).
Allows the users to walk around the scene without the limitation of standing or looking towards a specific sensor like real-life behavior. This by itself allows for a natural feeling both for participants that are physically in the scene and those who are joining remotely.
Creates for the users the perception of being virtually present within the room/scene although they are located remotely.
The user can interact with the device to control different views of the scene and/or to zoom in and out as needed.
The immersive experience is limited to the devices' field of view.
The output of the device is multiple live streams of the scene from physical and virtual sensors

The immersive experience based on at least some embodiments described herein may have different applications. For example, it may be used for educational purposes where each student can interact with the teacher or another student or an entire classroom lesson. Another example is online shopping, where the user may interact with the specific product or products, that the user is looking to purchase. Yet another example is for security, inspection, or monitoring purposes where the scene is constantly captured and the user may interact remotely to examine and inspect specific views or aspects of it.

The ability to create continuous multiple virtual sensors from multiple input physical sensors, optionally dynamically adapting the location of the different virtual sensors, may enable a unique broadcasting experience for example, for a concert, sports game, or a TV series. Once the event is captured with multiple sensors, at least some embodiments described herein enable using those sensors as input to the processing pipeline of creating multiple virtual sensors to produce a real-life immersive experience for the viewers.

It is noted that implementations are not necessarily dependent on the screen itself. Any multiple sensors that capture a scene, located on a common surface, may be used.

At least some embodiments described herein are designed to provide an ultimate interaction device to enhance the infinite number of daily human interactions with one another, with computing devices and with smart facilities. Monitors of today—from smartphones, tablets, PC displays, through mirrors, car displays, and large TVs-mainly enable one-way visual-only interaction, amid occupying the most precious ‘real-estate’ in our vicinity. At least some embodiments described herein may relate to a cheap OEM component that may revolutionize the way humanity conducts video calls, the way smart facilities learn and adapt to their owners, the way people are identified by their own devices, and the way one's privacy is truly protected. An open API may be provided to enable a plethora of applications rapidly developed by the world to enhance interaction in education, in gaming and AR, alongside security, medical-oriented, and defense uses.

The way people interact with the smart world around them is rapidly evolving. Yet, their day-to-day interaction means are based on none or poor visual sensing. While display monitors are mainly passive devices, excelling in transmitting one-way visual signals, and occupying wide spaces on desks and walls, human daily interaction requires a lot more to be transmitted back and forth.

Display monitors often lack integrated cameras, microphones, or speakers, and even when such accessories are attached to a monitor's frame, they suffer from having a local nature. A camera sees the world from a singular perspective. Same is true for a speaker or a microphone. More sophisticated appliances sometimes include dual cameras, or a variation of a depth camera, dual speakers, or a couple of microphones. Tablets and smartphones are by far the more advanced interaction devices, having a few cameras, speakers, and microphones integrated into their casing, with the purpose of redundancy and improved sensing.

Cameras attached to display monitors, like, in fact, any camera-a security cam, a phone cam, a web cam, or a single-lens reflex camera-compromise the privacy of the captured subject as well as the scene around that subject. Privacy protection may be a key factor in the design of an interaction device. The risk of privacy breach may also explain why current virtual personal assistants-respond to voice commands as the main channel of communication with their operators. Personal assistants based on at least some embodiments described herein understand gestures other than voice commands, learn the habits of their operators, and/or situations in their daily scenes.

At least some embodiments described herein provided one or more of the following:
1. Transfer both audio and video signals back and forth, in an integrated manner.
2. Capture and broadcast signals from a wide area, rather than from singular spots.
3. Bear sufficient redundancy to overcome occlusions and be robust to different modes of operation.
4. Capture depth information.
5. Protect the privacy of the captured subject at the highest level.
6. Understand gestures and learn scenes and habits.
7. Excel in identifying users by grasping biometry.

Since display monitors surround any modern facility, like homes or offices, turning those into interaction devices based on embodiments described herein capable of meeting the above requirements would transform control of those facilities, turning them into ‘smart’ facilities, without the need to add sensing equipment such as security cams or motion detectors. Smart homes and/or offices may benefit from the high-end, wide-area, 3D, privacy-protected sensing capabilities, and/or from the ‘surround’ effect of connecting all the interaction devices to one network inside the facility.

Moreover, applications based on those interaction devices based on embodiments described herein may transform the way people interact with one another in video calls. Eye contact may get back to daily interactions performed remotely. Gaze enables eye contact in video conferences with multiple participants, as described herein. Virtual reality and/or gaming experiences may upgrade and become more native. Fashion-oriented applications including online shopping may get to an enabling level. Remote training and/or tutoring could become easier, active monitoring of patients, care homes residents, or schools might benefit significantly.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

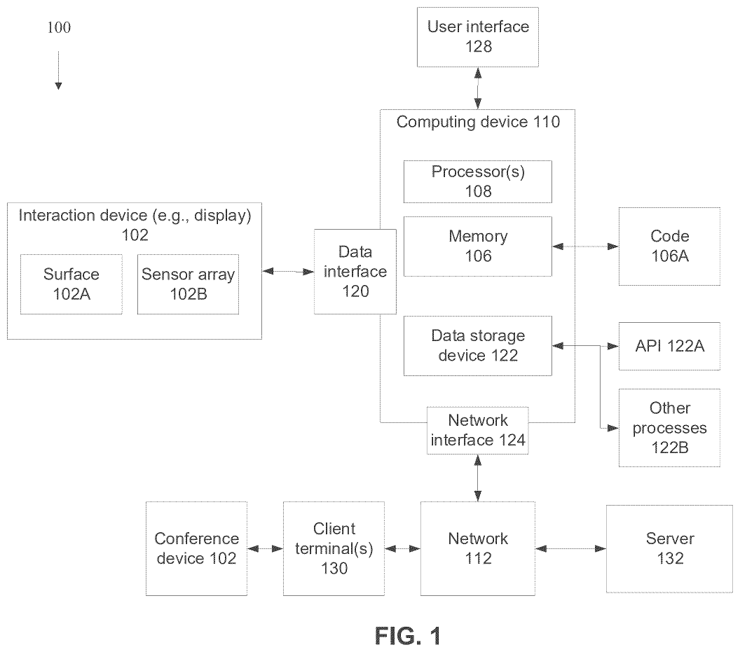

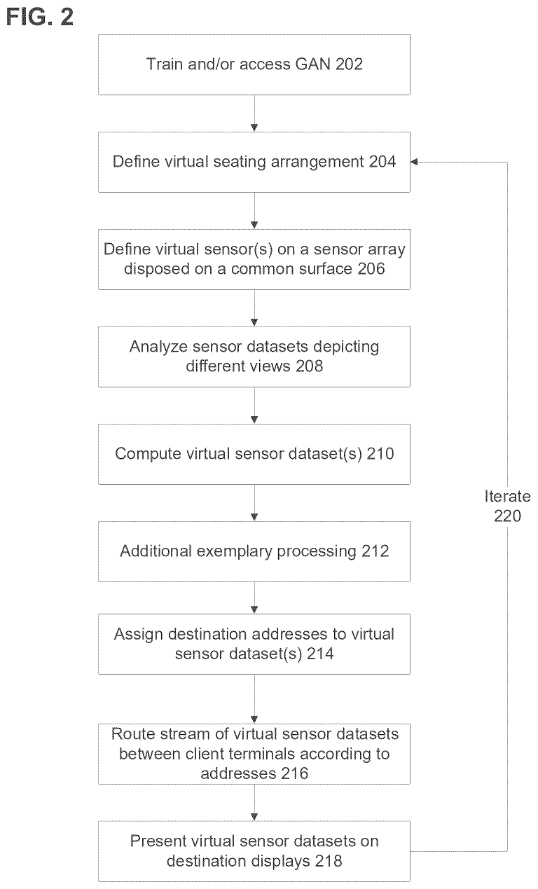

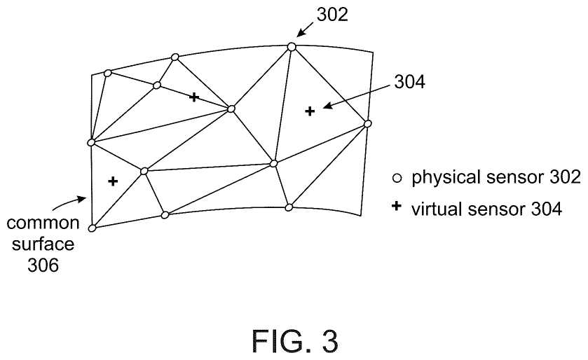

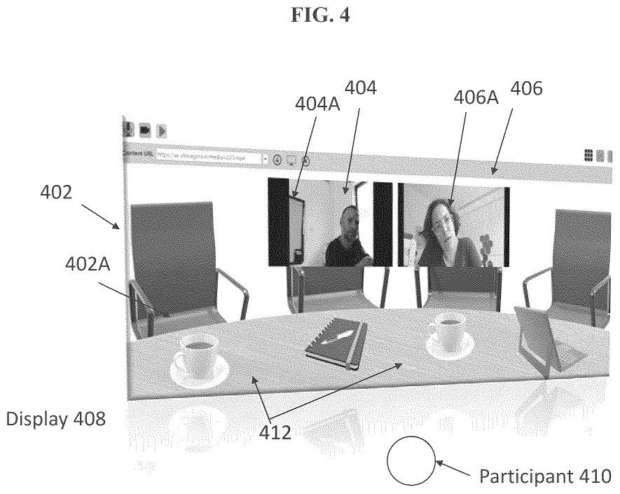

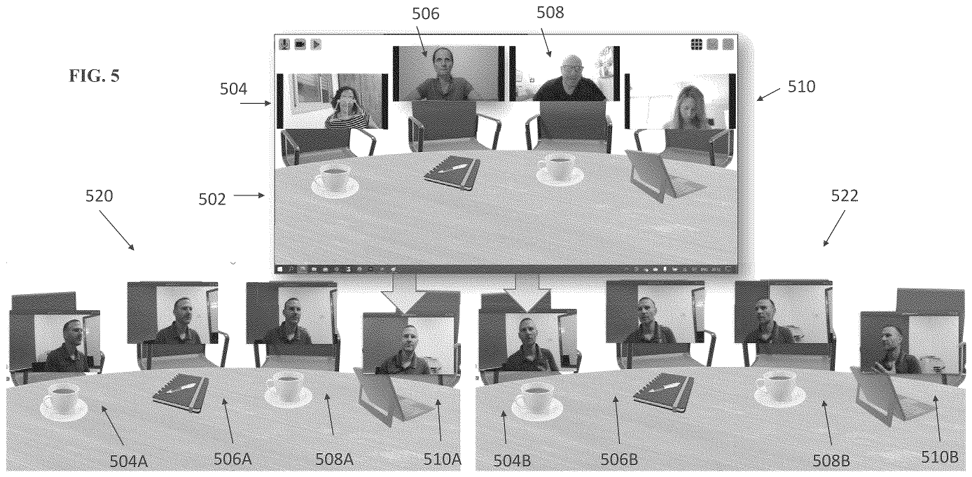

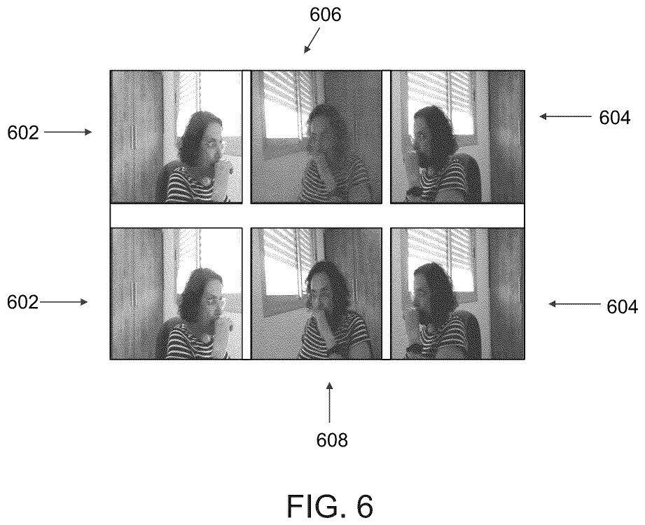

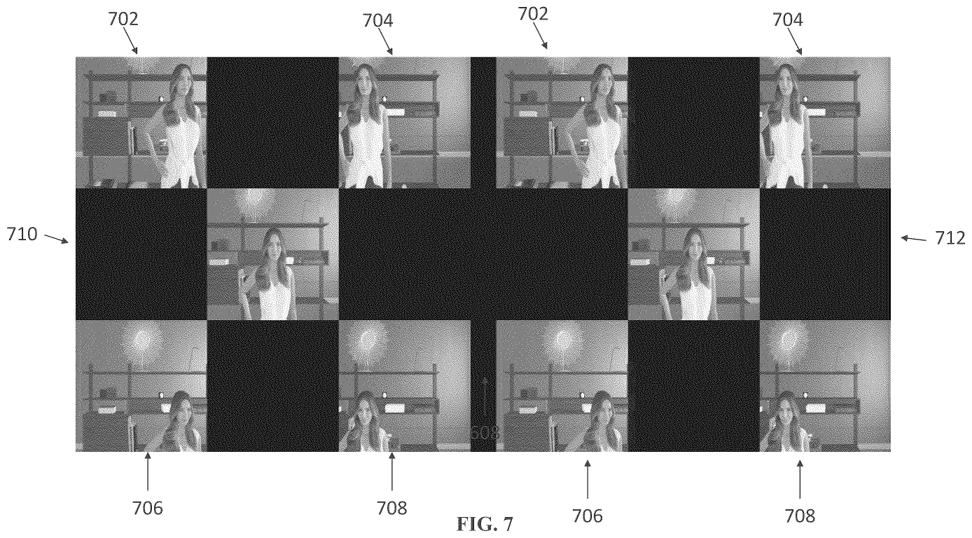

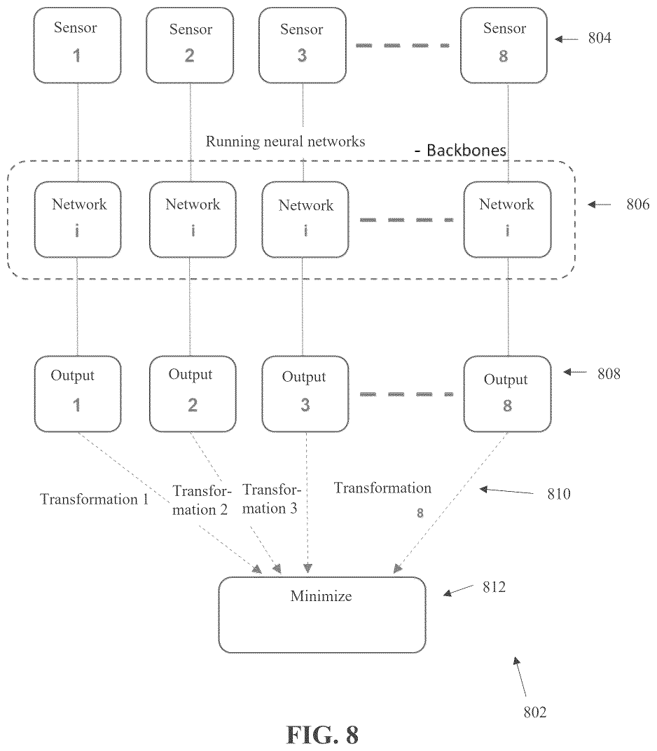

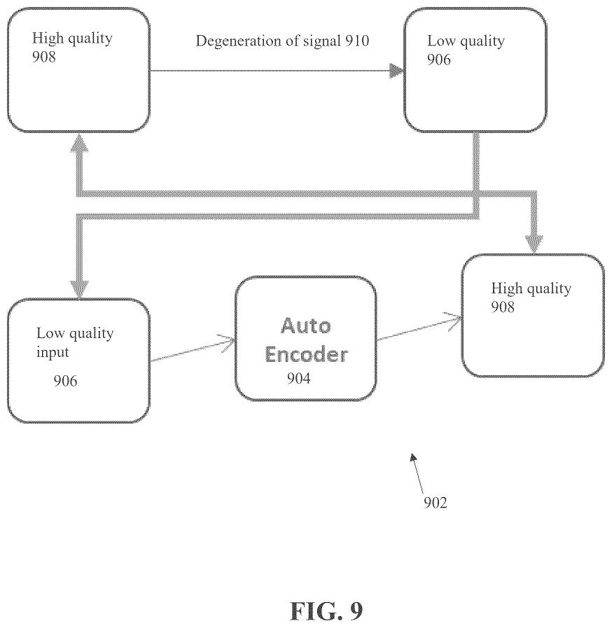

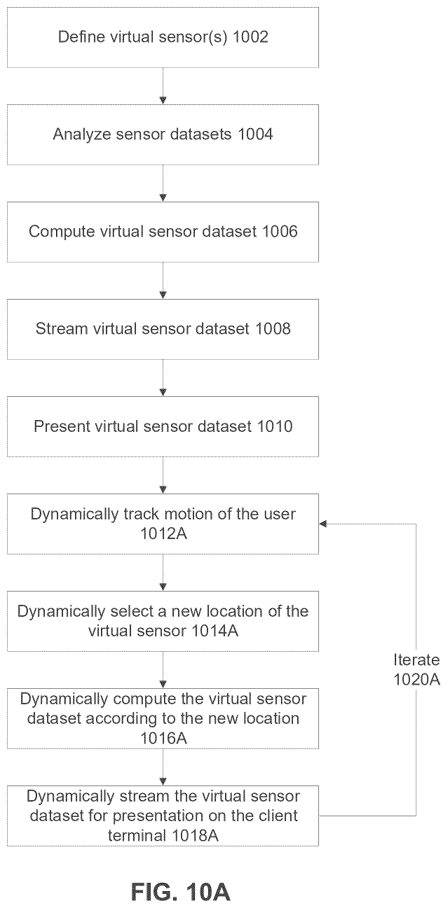

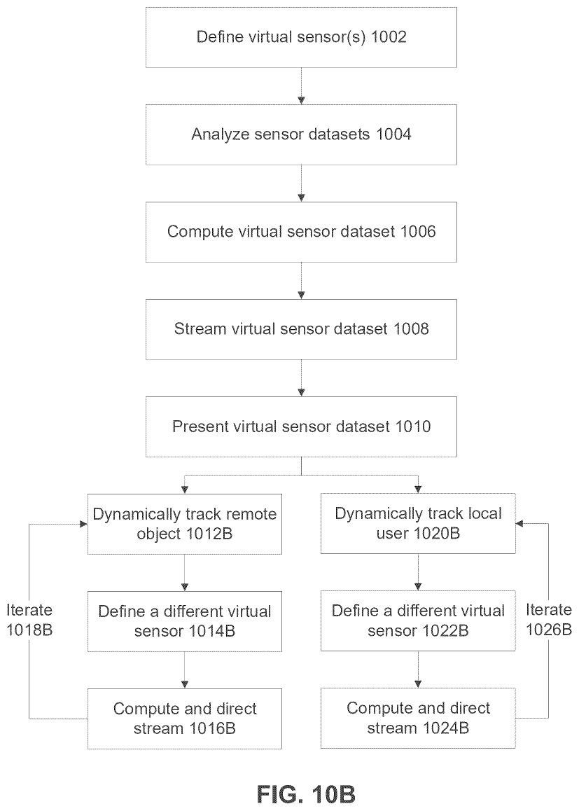

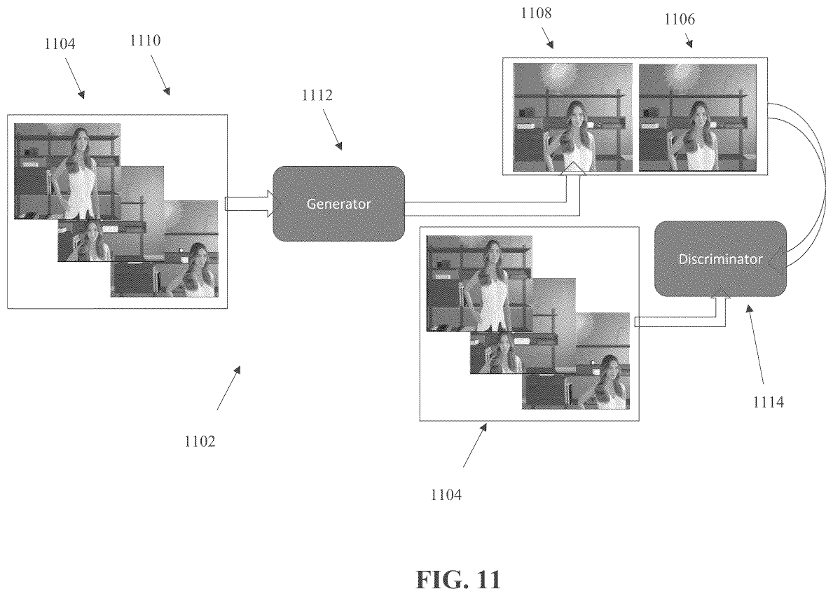

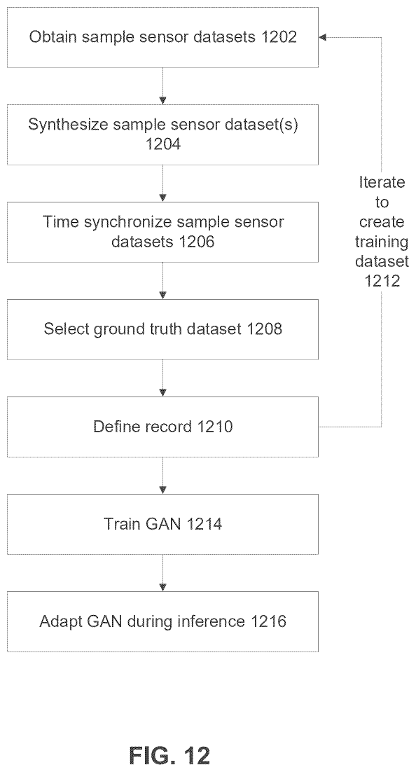

Reference is now made to FIG. 1, which is a block diagram of components of a system 100 for virtualizing sensors for interactions between participants in a virtual conference, in accordance with some embodiments of the present invention. Reference is also made to FIG. 2, which is a flowchart of a method for virtualizing sensors for interactions between participants in a virtual conference, in accordance with some embodiments of the present invention. Reference is also made to FIG. 3, which is a schematic depicting physical sensors and virtual sensors on a common surface, in accordance with some embodiments of the present invention. Reference is also made to FIG. 4, which is a schematic depicting selection of virtual sensors according to defined positions of participants participating in a virtual conference, in accordance with some embodiments of the present invention. Reference is also made to FIG. 5, which is a schematic depicting exemplary videos generated for different participants according to virtual sensors, in accordance with some embodiments of the present invention. Reference is also made to FIG. 6, which is a schematic depicting an experiment performed by Inventors for evaluation of embodiments described herein. Reference is also made to FIG. 7, which is a schematic depicting another experiment performed by Inventors for evaluation of embodiments described herein. Reference is also made to FIG. 8, which is an exemplary dataflow of training neural networks for processing inputs from sensors, in accordance with some embodiments of the present invention. Reference is also made to FIG. 9, which is an exemplary dataflow of training an autoencoder for converting low quality input obtained from one or more sensors into high quality output, in accordance with some embodiments of the present invention. Reference is also made to FIG. 10A, which is a flowchart of an exemplary flow of dynamically selecting a virtual sensor, in accordance with some embodiments of the present invention. Reference is also made to FIG. 10B, which is a flowchart of another exemplary flow of dynamically selecting a virtual sensor, in accordance with some embodiments of the present invention. Reference is also made to FIG. 11, which is a schematic of an exemplary GAN for generating output of a virtual sensor, in accordance with some embodiments of the present invention. Reference is also made to FIG. 12, which is a flowchart of an exemplary method for training the GAN for generating a virtual sensor dataset of a virtual sensor in response to an input of multiple sensor datasets of real sensors on a common surface. Reference is also made to FIG. 13, which is a schematic of an exemplary setup for providing an immersive experience without headset and/or other active engagement with a user interface, in accordance with some embodiment of the present invention.

System 100 may implement the acts of the method described with reference to FIGS. 2-13, optionally by a processor(s) 108 executing code instructions 106A stored in a memory 106 based on datasets captured by a sensor array 102B disposed on a common surface 102A of an interaction device 102.

Interaction device 102 may be implemented as, for example, a monitor. In such implementation, surface 102A may include the surface of the monitor.

Surface 102A may be flat (i.e., planar) and/or curved (e.g., convex, concave, wave).

Sensor array 102B may include one or more of the following sensors: optical sensors, imaging (e.g., camera), microphone, infrared, LIDAR, and the like.

A computing device 110 is in communication with interaction device 102. Computing device may include one or more of the following components: processor(s) 108, memory 106, data storage device 122, data interface 120, and/or network interface 124.

It is noted that there are multiple interaction devices 102 and associated computing devices 110, which communication with each other over a network 112 optionally via server 132 (which may forward streams of virtual sensor datasets according to source and/or destination subscriptions as described herein) that participate in the virtual conference.

Computing device 110 may be implemented as, for example, a component integrated within interaction device 102, an external component connected to interaction device 102 (e.g., set up box that is plugged into a port of interaction device 102), and/or a client terminal (e.g., 130) that may be connected (e.g., dynamically connected and/or dynamically disconnected) to interaction device 102. The client terminal (e.g., 130) implementation of computing device 110 may be locally connected to interaction device 102 (e.g., via a wire connection and/or wireless connection), and/or may be remotely connected to interaction device 102 (e.g., via a network). Computing device 110 may be implemented as, for example, a client terminal, a server, a virtual server, a virtual machine, a computing cloud, a mobile device, a desktop computer, a thin client, a Smartphone, a Tablet computer, a laptop computer, a wearable computer, glasses computer, and a watch computer.

Computing device 110 may be connected to interaction device 102 using one or more data interfaces 120, for example, a wire connection (e.g., physical port), a wireless connection (e.g., antenna), a local bus, a port for connection of a data storage device, a network interface card, other physical interface implementations, and/or virtual interfaces (e.g., software interface, virtual private network (VPN) connection, application programming interface (API), software development kit (SDK)).

Processor(s) 108 may be implemented, for example, as a central processing unit(s) (CPU), a graphics processing unit(s) (GPU), field programmable gate array(s) (FPGA), digital signal processor(s) (DSP), application specific integrated circuit(s) (ASIC), and circuitry. Processor(s) 108 may include one or more processors (homogenous or heterogeneous), which may be arranged for parallel processing, as clusters and/or as one or more multi core processing units.

Memory 106 stores code instruction for execution by processor(s), for example, a random access memory (RAM), read-only memory (ROM), and/or a storage device, for example, non-volatile memory, magnetic media, semiconductor memory devices, hard drive, solid state drive, and removable storage. For example, memory 106 may store code 106A that implement one or more acts and/or features of the methods described herein.

Data storage device 122 stores data, for example, API 122A (as described herein), and/or other processors 122B, for example, operating system processes, and/or other applications which access API 122A, as described herein. Data storage device 122 may be implemented as, for example, a memory, a local hard-drive, a removable storage device, a solid state drive, an optical disk, a storage device, and/or as a remote server and/or computing cloud (e.g., accessed over a network). It is noted that API 122A and/or other processes 122B dataset(s) 116 may be stored in data storage device 122, with executing portions loaded into memory 106 for execution by processor(s) 108.

Network interface 124 connects to network 112. Network interface 124 may be implemented as, for example, one or more of, a network interface card, a wireless interface to connect to a wireless network, a physical interface for connecting to a cable for network connectivity, a virtual interface implemented in software, network communication software providing higher layers of network connectivity, and/or other implementations.

It is noted that data interface 120 and network interface 124 may exist as two independent interfaces (e.g., two network ports), as two virtual interfaces on a common physical interface (e.g., virtual networks on a common network port), and/or integrated into a single interface (e.g., network interface).

Network 112 may be implemented as, for example, the internet, a local area network, a virtual network, a wireless network, a cellular network, a local bus, a point to point link (e.g., wired), and/or combinations of the aforementioned.

Computing device 110 may communicate using network 112 (or another communication channel, such as through a direct link (e.g., cable, wireless) and/or indirect link (e.g., via an intermediary computing device such as a server, and/or via a storage device), for example, with one or more client terminals 130 and/or server(s) 132. Server 132 may forward streams of virtual sensor datasets between interaction devices 102 according to originating and/or destination addresses indicating participants, as described herein. Client terminals 130 and connected interaction devices 102 are of different participants participating in the virtual conference.

It is noted that in some embodiments interaction device(s) 102 may connect to network 112 directly, without using client terminal 130.

Computing device 110 includes and/or is in communication with one or more physical user interfaces 128 that include a mechanism for additional user interaction, for example, to enter data and/or to view data. User interface 128 may be in addition to interaction device 102 102, and/or integrated within interaction device 102, and/or be implemented as interaction device 102. A client terminal such as 130 (e.g., smartphone) may be used as user interface 128. Exemplary physical user interfaces 128 include, for example, one or more of, a touchscreen, a display, a keyboard, a mouse, and voice activated software using speakers and microphone.

Referring now back to FIG. 2, at 202, a generative adversarial network (GAN) for synthesis of a virtual image, for example, of a participant participating in a conference, is trained and/or a trained GAN is accessed.

Referring now back to FIG. 11, an exemplary GAN 1102 is depicted. GAN 1102 is trained on a generated multi-record training dataset. A record comprises: a plurality of sensor datasets 1104 depicting different views of the participant captured by a plurality of sensors disposed on a common surface, and a ground truth view 1106 of the participant captured by a ground truth sensor. GAN 1102 is trained for generating a virtual sensor dataset 1108 corresponding to a virtual sensor in response to an input of a plurality of sensor datasets 1110 captured by a plurality of sensors of the common surface. A generating component (i.e., generator) 1112 is adapted during training on feedback from a discriminator component 1114 for generating virtual sensor datasets 1108 that the discriminator component cannot accurately distinguish from ground truth 1106.

Referring now back to 202 of FIG. 2, exemplary GAN based architectures include: Pix2Pix, Generator: U-Net, Discriminator: PatchGAN, Fusion of multiple inputs from multiple sensors, Generator: U-Net with DenseNet as a back one, U-Net++, U-Net with transformers. Additional architectures for memory (LSTM, conv-LSTM, GRU), Discriminator: ResNet, DenseNet other SOTA classification architecture. Multiple input fusion: Naïve, fuse inputs at the last layer of the encoder, additional CNN for input fusions.

Referring now back to FIG. 12, a flowchart of an exemplary method for training the GAN for generating a virtual sensor dataset of a virtual sensor in response to an input of multiple sensor datasets of real sensors on a common surface, is depicted.

At 1202, sample sensor datasets are obtained. The sample sensor datasets may be obtained from a single sensor array of a common surface (e.g., display), which includes multiple sensors at different locations on the surface, for example, as described herein.

The sample sensor datasets depict different views of the same scene, obtained from sensors of a sensor array on a common surface. The sample sensor datasets may be obtained, for example, as individual datasets, and/or as a sequence of datasets.

The sample sensor datasets may be images captured by the sensors of the sensor array.

At 1204, additional sample sensor datasets may be synthesized, for example, by another GAN and/or another ML model. Alternatively or additionally, the ground truth may be synthesized. The synthesis may increase the available data for training, and/or fill in gaps in the available data.

The synthesis may be done, for example, by computing a 3D model from the 2D images captured by sensors. Additional 2D images representing additional sample sensor datasets and/or the ground truth virtual dataset may be extracted from the 3D model, for example, by projection of the 3D model to a different plane corresponding to the additional sample sensor dataset. It is noted that the trained GAN directly synthesizes the virtual dataset of the virtual sensor, rather than requiring generating a 3D model and then extracting a 2D image, which is computationally inefficient for being performed in real-time for immersive experiences and/or for video conferencing.

Optionally, one or more records includes sample sensor datasets and/or the ground truth, which may be produced synthetically from the 3D simulation.

At 1206, the sample sensor datasets may be pre-processed.

Optionally, the pre-processing includes time synchronizing the sample sensor datasets, such that sensor datasets obtained at substantially a same time interval are identified and/or synchronized with each other. The synchronization may ensure, for example, that all images of a sensor array are captured at substantially the same time, depicting different views of the same object at the same time. This enables training the GAN to synthesize sensor datasets for virtual sensors which do not have corresponding physical sensors.

Alternatively or additionally, the pre-processing may include concatenating the sensor datasets (e.g., images) from the different sensors.

Alternatively or additionally, the pre-processing may include color-to-gray conversion.

Alternatively or additionally, the pre-processing may include unit normalization.

Alternatively or additionally, the pre-processing may include providing a hint for use during training.

At 1208, one or more of the sample sensor datasets may be selected as the target sensor and ground truth indicating a virtual sensor dataset of a virtual sensor representing a certain view. The location of the virtual sensor may be selected, and the sensor datasets corresponding to the location of the virtual sensor may be defined. Training may be performed multiple times, where during each training cycle a different sensor dataset is selected as the target sensor and ground truth.

At 1210, a record of sample sensor datasets, optionally time synchronized, that includes the ground truth may be created.

Optionally, the sample sensor datasets of the record include a sample time synchronized sensor dataset, and the ground truth dataset includes a ground truth time synchronized sensor dataset.

Optionally, the sample sensor datasets of the record include sample videos including sequentially captured frames, and the ground truth dataset includes a ground truth video including sequentially captured frames. The sample videos and the ground truth video may be are simultaneously captured, and stored in the record in a time synchronized manner.

Alternatively or additionally, the sample sensor datasets of the record include sample audio recordings including sequentially captured audio recordings, and the ground truth dataset includes a ground truth audio recording including sequentially captured audio recordings. The sample audio recordings and the ground truth audio recording may be simultaneously captured, and stored in the record in a time synchronized manner.

Alternatively or additionally, the record includes locations and/or views for each same sensor dataset, and a location and/or view for the sensor dataset representing the ground truth. For example, coordinates on the display, relative distances between sensors, and/or pose of the sensor viewing direction (e.g., in 6 degrees of freedom or other coordinate system). The location enables training the GAN to synthesize sensor datasets for virtual sensors which do not have corresponding physical sensors, given a location on the common surface which does not correspond to a physical sensor.

At 1212, one or more features described with reference to 1202-1210 may be iterated for creating multiple records. For example, using sample sensor datasets obtained over subsequent time intervals, and/or obtained from different sensor arrays on different common surfaces.

The records may include datasets of a similar nature, for example, video, audio, and/or of similar objects such as humans, cars, and the like.

Optionally, the training dataset includes locations for each of the sample sensor datasets, a ground truth location for the ground truth view.

At 1214, the GAN is trained on the training dataset.

The GAN may be trained using a supervised approach, using the designated ground truths.

Exemplary loss functions used during training include adversarial loss, L1 loss, and/or combination of the adversarial loss and L1 loss, and the like.

The virtualization machine learning model may include a generative adversarial network comprising a generator component and a discriminator component. The generator component generates an outcome of virtual sensor dataset corresponding to a virtual sensor in response to an input of sensor datasets captured by sensors. The generating component is adapted during training on feedback from the discriminator component for generating virtual sensor datasets that the discriminator component cannot accurately distinguish from ground truth datasets captured by a ground truth sensor.

Optionally, the generator component is trained on the training dataset of records. Each record includes the sample sensor datasets depicting different views, and the ground truth dataset depicting the ground truth view of the ground truth sensor representing the virtual sensor.

When the training dataset includes an indication of location and/or view of the sensors, during training the generator component is trained for generating the virtual sensor view at a target location in response to an input of the target location and the sample sensor datasets.

Exemplary pre-training and continual learning: Virtual sensor model training: the network is trained on multiple inputs from multiple positions on the common surface, learning to output any virtual sensor based on its position. Signal positions are optionally provided as input to the network. The network may be trained on a large amount of data, including a mixture of synthetic and real data (pre-training).

At 1216, the GAN may be adapted and/or further trained during inference, using real-time sensor datasets.

At run time, the processor may tune the last layers of the network (transfer learning) through online (continual) learning, to adapt to the interpolation task of current streams. During pre-training ground truth is available for the desired positions (virtual sensors). The adaptation at run-time may be based on a smaller number of physical sensors. The processor may randomize a sub-group of physical sensors to produce the input signals, while the rest of the sensors produce the ground truth for the training. The result of the pre-training and the adaptation may be a virtual signal from any desired position. A Student-Teacher scheme for the above combination may be considered.

Referring now back to FIG. 2, at 204, a virtual seating arrangement may be defined for participants participating in the conference. The participants may include the first participant associated with a certain sensor array, and of second participants remotely interacting with the first participant via the conference. A virtual seating arrangement may be defined for the participants participating in the conference, and for each sensor array of each of the plurality of participants. Locations of the virtual sensors may be defined on the sensor array according to the virtual seating arrangement. The virtual sensors at the defined locations may be mapped to the second participants according to the defined virtual seating.

Optionally, for each sensor array of each of the participants the following may be performed: virtual sensors may be defined. Each one of the virtual sensors may representing a respective face-on view from one of the second participants viewing the first participant. Virtual sensor datasets (e.g., as in 210) may be computed for the virtual sensors according to the analysis (e.g., the analysis as described with reference to 208). The streams of the virtual sensor datasets from the sensor array of the first participant may be forwarded to the sensor arrays of the second participants (e.g., as described with reference to 216).

Optionally, the virtual seating arrangement defines a relative location of each of the participants. Each sensor array may be associated with a display. A presentation of each of the participants may be located on the display in an order corresponding to the virtual seating arrangement. Each virtual sensor may correspond to each participant virtually positioned at each presentation location on the display.

At 206, a virtual sensor is defined on a sensor array disposed on a common surface. The virtual sensor may be defined on the remotely located sensor array. The virtual sensor may be selected for generating a single face-on view of a first participant as seen remotely by a second participant participating in a conference.

The location of the virtual sensor may be defined on the sensor array.

The virtual sensor may be selected, for example, automatically by code (e.g., based on tracking the participant, the user, and/or an object, as described herein), manually by a user, and/or based on a set of rules, and the like.

Examples of, the virtual sensor, the virtual sensor dataset, the sensor datasets, and/or the sensor array include: (i) a virtual video camera, a virtual video, captured videos, and physical video camera, and (ii) a virtual audio track, a virtual microphone, captured audio tracks, and physical microphones.

Examples of sensors of the sensor array include imaging sensors and/or audio sensors.

Optionally, the common surface is implemented as a display. The sensor array may be implemented as imaging sensors arranged in a grid and/or other pattern, optionally located behind and/or within the screen. The imaging sensors are spaced part and distributed across a width and length of the screen. Pixels are disposed between spaced apart imaging sensors.

Optional features of the common surface sensor array: audio and/or visual sensors that lie on a common surface. The surface can be of a display monitor-planar or curved. Other sensors such as IR, LiDAR, smell, may be included. The sensor array may have any geometry within the common surface.

Optional goals of the sensor array: act as one sensing device capturing scenes from a wide area. The sensor array may be designed to provide one or more of the following: premium audio-visual experience, true gaze, directional sound & perception, sentiment and/or gesture recognition, and biometry and/or privacy protection.

At 208, the sensor datasets of the sensor array are analyzed. The sensor datasets depict an object from different views. The object may be, for example, the first participant and/or an inanimate object that may be still or move (e.g., vehicle).

Optionally, the analysis is performed by feeding the sensor datasets into the virtualization machine learning model (e.g., GAN) that generates the virtual sensor dataset as an outcome thereof.

At 210, a virtual sensor dataset is computed for the virtual sensor according to the analysis. The virtual sensor dataset may be obtained as an outcome of the virtualization machine learning model (e.g., GAN).

The virtual sensor dataset may be computed according to the location of the virtual sensor.

Alternatively or additionally, when each sensor of the sensor array is configured for outputting a compromised quality dataset depicting a partial field of view, the virtual sensor dataset is computed by stitching compromised quality datasets into a main dataset at higher quality that depicts a full field of view.

The stitching may be done by feeding the compromised quality datasets into a stitching ML module that generates the main dataset as an outcome thereof. The stitching ML model may be trained on a stitching training dataset of multiple records, where each record includes a sample of compromised quality datasets and a ground truth main dataset obtained from at least one of: a high quality sensor and a synthesized dataset.

Optionally, each compromised quality dataset of each sensor is fed into an autoencoder that extracts an encoding. Multiple encodings obtained from multiple autoencoders may be fed into the stitching ML model. The stitching ML model and the autoencoders may be jointly trained end to end.

At 212, one or more additional exemplary processing features are implemented. Some exemplary processing features are now described. It is noted that one or more additional processing features may be implemented at different phases of the process described with reference to FIG. 2, and not necessarily at 212, for example, with respect to 204-210, and/or in between and/or in parallel to the features.

Optionally, the virtual sensor dataset includes a depth map indicating a respective depth for each data element of the virtual sensor dataset relative to a normal at a location of the virtual sensor. The depth map may be used, for example, for enhancing the virtual immersive experience and/or interactions between participants, for example, as described herein.

Optionally, the depth map is computed by feeding the datasets into a depth ML model. The depth ML model may be trained on a depth training dataset of multiple records, where each record includes sample sensor datasets and a ground truth of a sample depth map.

Optionally, the sensor datasets are merged into a lattice in which each sensor dataset is positioned based on location in space of the corresponding sensor on the common surface. The lattice represents a single dataset in which relative location of each sensor is defined. Multiple positions of the lattice may be converted into indications of depth relative to the virtual sensor for computing the depth map for the virtual sensor dataset.

At 214, when there are multiple participants and/or multiple users interacting with each other, a destination address may be assigned to each of the streams of each of the sensor arrays of each of the participants. The destination address may indicate the respective second participant associated with the respective virtual sensor of the respective sensor array. Each stream is routed according to the destination address for presentation on a client device of the second participant. When there are multiple participants and/or multiple users, the multiple streams are routed to the correct client terminal according to the destination address.

At 216, a stream of the virtual sensor dataset may be directed to a client terminal of a user (e.g., second participant), for providing the enhanced immersive experienced and/or for depicting a single face-on view of the first participant as viewed from the visual sensor by the second participant.

The streams of the sensor arrays of each of the participants are transmitted to a central server that maps and forwards the streams to destinations of client terminals of the second participants.

Optionally, a virtual conference manager for common-surface sensor array is provided. The virtual conference manager may allow each sensor-array owner to publish multiple streams and subscribe to multiple streams. Each stream is coming out from a sensor-array owner may be addressed to a specific participant—referred to as targeted streams. The manager may also be executing the ‘interpolator’ for performance trade-off. Pros and cons for both peer-to-peer and client/server schemes.

At 218, the routed virtual sensor datasets may be presented on the common surfaces of the client terminals of the participants and/or users.

At 220, one or more features described with reference to 204-218 may be iterated one or more times.

Optionally, during the iterations, the virtual seating arrangement (e.g., as described with reference to 204) may be dynamically adapted. In response to the adaptation of the virtual seating arrangement, different location(s) of the virtual sensor(s) of the common surface (e.g., as described with reference to 206) may be selected. The virtual sensor datasets, which depict the new views based on the adapted location(s) of the virtual sensor(s), are routed to the client terminals, and presented on the destination displays.

Referring now back to FIG. 10A, a flowchart of an exemplary approach for an immersive experienced without headset and/or other active engagement with a user interface (e.g., joystick) is provided. Features described with reference to FIG. 10A may be based on, and/or include, one or more features described with reference to FIG. 2.

Referring now back to FIG. 13, the schematic of the exemplary setup for providing an immersive experience without headset and/or other active engagement with a user interface, is provided.

In some features of FIG. 10A, reference will also be made back to FIG. 13 to aid in understanding.

A common surface is implemented as a display 1302, with a sensor array 1304 embedded within display 1302. A user 1306 is located remotely viewing images 1324 on a client terminal 1308. A camera 1310 located remotely in proximity to client terminal 1308 captures images of user 1306, and sends images 1320 for presentation on display 1302 (i.e., the common surface). Image 1320 presented on display 1302 depicts user 1306 captured by camera 1310. User 1306 captured by camera 1310 is presented within image 1320 as user 1306A. Camera 1310 may be another virtual sensor located on another common surface created from another sensor array capturing images of the user, or a standard camera capturing a video. A first participant or other scene 1312 (e.g., baseball game, concert, safari) may be located in proximity to display 1302 (e.g., the common surface), in which case user 1306 in proximity to the display of client terminal 1308 is the second participant referred to herein. User 1306 is shown with a hat help distinguish from scene 1312 which includes another stick figure with long hair and a potted tree. The stream of the virtual sensor dataset corresponding to a location of a virtual sensor 1322 on display 1320 depicting first participant and/or scene 1312, is streamed from the common surface (e.g., display) 1302 to the client terminal 1308, for viewing by the second participant 1306 as image 1324. Scene 1312A presented on client terminal 1324 is scene 1312 depicted as captured by the location of virtual sensor 1322.

At 1002, a virtual sensor(s) is defined on a sensor array located on a common surface, for example, as described with reference to 206 of FIG. 2.

At 1004, sensor datasets of the sensor array captures from different views are analyzed, for example, as described with reference to 208 of FIG. 2. The sensor datasets may be analyzed by feeding to a trained ML model, optionally a GAN, as described herein. The sensor dataset are obtained by the remote sensor array.

At 1006, a virtual sensor dataset for the virtual sensor is computed, for example, as described with reference to 210 of FIG. 2. Optionally, the virtual sensor dataset is obtained as an outcome of the trained ML model, optionally the GAN. The virtual sensor dataset is for the location of the virtual sensor

At 1008, a stream of the virtual sensor dataset is directed to the client terminal, optionally of a user (e.g., referred to herein as the second participant), for example, as described with reference to 216 of FIG. 2.

At 1010, the streaming virtual sensor dataset is presented on a display of the client terminal, for example, as described with reference to 218 of FIG. 2.

At 1012A, motion of the user across the display (i.e., the common surface) is dynamically tracked to identify a new location of the user on the display (i.e., the common surface).

With reference to FIG. 13, motion of user 1306A across display 1302 is dynamically tracked, for example, identify a new location of the user 1306B on display 1302. To help distinguish, user 1306A is shown in bold, following by a dotted arrow indicating the changing location (the dotted arrow is not presented on display 1302 but is merely there to help the reader following the change in location), and new location of user 1306B is shown using dots. It is to be understood that user at new location 1306B replaces user at preceding location 1306A, and are not presented simultaneously, but are shown simultaneously on display 1302 to aid the reader's understand of changing locations.

Optionally, the motion of the user across the display may be tracked by analyzing the image of the user presented on the display to detect movement of the user. For example, when the user physically changes their position such as moving their body to the left, the physical change is depicted as movement to the left in the image on the display.

Alternatively or additionally, the image of the user may be presented within a window on the display, for example, within a user interface (GUI) that presents different participants in a conference call. The window of the image of the user may be moved to a different location on the display, for example, by the first participant located in front of the display, and/or by automatically by code. The new location on the display is tracked.

At 1014A, in response to the new location of the user on the display, a new location of the virtual sensor on the display is selected. The new location of the virtual sensor may correspond to the new location of the user on the display, and/or may correspond to how the user is viewing a scene being captured by the sensor array from the new location of the user on the display.

With reference to FIG. 13, in response to new location 1306B of the user on display 1302, a new location 1322B of the virtual sensor 1322 is selected. To help distinguish, virtual sensor 1322 is shown in bold, following by a dotted arrow indicating the changing location (the dotted arrow is not presented on display 1302 but is merely there to help the reader following the change in location), and new location 1322B is shown using dots. It is to be understood that new location of the virtual sensor 1322B replaces the preceding location of the virtual sensor 1322, and are not necessarily used simultaneously, but are shown simultaneously on display 1302 to aid the reader's understand of changing locations.

At 1016A, the virtual sensor dataset is computed for the new location of the virtual sensor.

At 1018A, the stream of the virtual sensor dataset is directed to the client terminal. The user, whose location on the display (i.e., the common surface) is being tracked, views the dynamically updated stream on the client terminal.

With reference to FIG. 13, in response to new location 1322B of the virtual sensor, scene 1312A is now presented within image 1324 (presented on client terminal 1324) in a new location, as scene 1312B. To help distinguish, scene 1312A is shown in bold, following by a dotted arrow indicating the changing location (the dotted arrow is not presented on client terminal 1308 but is merely there to help the reader following the change in location), and new location of scene 1312B is shown using dots. It is to be understood that new location of scene 1312B replaces preceding location of scene 1312A, and are presented simultaneously, but are shown simultaneously on display 1308 to aid the reader's understand of changing locations.

In summary, in response to changing movement of user 1306A to 1306B on display 1302, location of the virtual sensor is moved from 1322 to 1322B on display 1302, which triggers change of scene 1312A to scene 1312B on client terminal 1308 which is being viewed by user 1306, leading to the virtual immersive experience without headset described herein.

At 1020A, one or more features described with reference to 1012A-1018A are iterated.

The iterations may generate a virtual immersive experience for the user, that does not require a headset and/or other active interface action by the user (e.g., joystick). The image presented on the display of the client terminal is dynamically adapted to different views of the scene (which is viewed by the user) according to physical location changes of the user viewing the client terminal, without requiring active engagement of the user with a physical user interface such as headset and/or joystick.

Reference is now made to FIG. 3, which is a schematic depicting physical sensors 302 and virtual sensors 304 on a common surface 306, in accordance with some embodiments of the present invention. Physical sensors 302 may be, for example, cameras, speakers, microphones, and other sensors described herein. Physical sensors 302 may be located (e.g., embedded) within common surface 306, for example, a display. Virtual sensors 304 may be virtually located anywhere within common surface 306. It is noted that virtual sensors 304 may be located on regions of common surface 306 where no physical sensors 302 are located, or may correspond to a location of a physical sensor 302. For example, physical sensors 302 may be located on the external borders of the display so as not to disrupt the presentation on the display, and virtual sensors are defined within the interior of the display. In another example, when the virtual sensor corresponds to a location of a physical sensor, the data from the other physical sensors may be used, for example, to increase the resolution of the images of the physical sensors, as described herein.

Reference is now made to FIG. 4, which is a schematic depicting selection of virtual sensors 402A, 404A and 406A according to defined positions of participants 402, 404, and 406 participating in a virtual conference, in accordance with some embodiments of the present invention. Location of participants 402 404 and 406 is defined relative to a common surface 408 (e.g., display), optionally corresponding to where images of the respective participants are presented on display 408. For example, a location indicated by an empty chair is reserved for participant 402 on the left side of display 408. An image of participant 404 is presented in the middle of display 408. An image of participant 406 is presented on the right of display 408. Virtual sensor 402A is defined to correspond to the location of participant 402, to provide participant 402 with a view of a user 410 viewing display 408 from the left side. Virtual sensor 404A is defined to correspond to the location of participant 404, to provide participant 404 with a view of user 410 viewing display 408 from the middle. Virtual sensor 406A is defined to correspond to the location of participant 406, to provide participant 406 with a view of user 410 viewing display 408 from the right side. As described herein, the virtual sensors provide a more realistic remote experience, simulating participants 402, 404, 406, and 410 sitting together around a table in a real conference room, by depicting gaze between participants as would be experienced in a real life conference room. For example, when participant 410 is making eye contact with the image of participant 406 on the right side of display, participant 406 sees on her display the feed from virtual sensor 406A, depicting participant 410 looking directly at her. Simultaneously, participant 404 sees on his display the feed from virtual sensor 404A, depicting participant 410 looking slightly to the right, which participant 404 can interpret as participant 410 looking at participant 406. At the same time, participant 402 (when present) will see on the display the feed from virtual sensor 402BA, depicting participant 410 looking strongly to the right, which participant 402 can interpret as participant 410 looking at participant 406.

Alternatively or additionally to gaze, the virtual sensors may provide a more realistic audio experience, by directing audio between different remotely located participants, for simulating audio experiences as would otherwise be experienced in a real life conference room, for example, indicating direction of speech between different participants. Virtual datasets corresponding to virtual sensors 402A, 404A, and 406A are computed based on datasets obtained from real sensors 412 (e.g., video and/or audio), as described herein.

Reference is now made to FIG. 5, which is a schematic depicting exemplary videos generated for different participants according to virtual sensors, in accordance with some embodiments of the present invention. A main participant of a virtual conference is viewing a display 502 (i.e., common surface) presenting videos of four other participants 504, 506, 508, and 510 participating in the conference. The location of the four other participants, including the main participant, are defined. For example, as shown, participant 504 is sitting on the left. Participant 510 is sitting on the right. Participant 506 is to the right of participant 504 and to the left of participant 508. Participant 508 is to the left of participant 510 and to the left of participant 506. Virtual sensors are defined for each one of the other participants, for example, virtual sensors are virtually defined on display 502 corresponding to the center of videos of participants 504, 506, 508, and 510 as presented on display 502. Display 502 includes an array of imaging sensors and/or audio sensors (e.g., microphones) as described herein.

Schematic 520 depicts views as seen on the displays being viewed by participants 504, 506, 508, and 510, created based on the location of the virtual sensors on display 502. Schematic 520 depicts the case of the main participant gazing at participant 510. I.e., the main participant, which is sitting in front of display 502, is looking towards the video of other participant 510 presented on the right side of display 502. Recall that a virtual sensor is defined for other participant 510 at the location on display 502 where the video of participant 510 is presented.

Now, schematic 510A depicts the view as presented on the display of other participant 510 based on the virtual sensor defined for the location on display 502 where the video of other participant 510 is presented. Participant 510, viewing video 510A, sees the face of main participant head on, i.e., since the main participant is gazing at participant 510 during a conversation. Video 510A depicts the view as if the main participant was looking straight towards participant 510 in a real life conference room.

Schematic 504A depicts the view as presented on the display of other participant 504 based on the virtual sensor defined for the location on display 502 where the video of other participant 504 is presented. Participant 504, viewing video 504A, sees the left side of the face of main participant. Video 504A depicts the view as if participant 504 was sitting to the far left of the main participant in a real conference room, while the main participant is looking towards the other participant 510 sitting to the far right.

Similarly, schematic 506A depicts the view as presented on the display of other participant 506, and schematic 508A depicts the view as presented on the display of other participant 508. Schematic 508A and 506A depict increasing side views of the left side of the face of the main participant, as seen by participant sitting further to the left.

Schematic 522 depicts the case of the main participant gazing at the location on display 502 corresponding to participant 504. Now, participant 504 viewing video 504B sees main participant face-on, like in a real meeting room when the main participant is gazing straight towards the other participant 504. Videos 506B, 508B, and 510B, show progressively increasing angled views of the main participant, as seen by participants 506, 508, and 510, which are ordered to the right of participant 504.

Reference is now made to FIG. 6, which is a schematic depicting an experiment performed by Inventors for evaluation of embodiments described herein. Images 602 and 604 which depict a person, are respectively captured by cameras located to the left and to the right of the person. Image 606 is created based on images 602 and 604, as described herein, according to a virtual sensor virtually placed in front of the person, between the left and right cameras. Image 608, which is captured by a real camera placed right in front of the person, between the left and right cameras, is very similar to image 606. The similarity between images 606 and 608 indicate the ability to generate virtual images from virtual sensors using data obtained from other sensors located at other locations.

Reference is now made to FIG. 7, which is a schematic depicting another experiment performed by Inventors for evaluation of embodiments described herein. Images 702, 704, 706, and 708 which depict another person, are respectively captured by cameras located at four corners, top left, top right, bottom left, and bottom right, relative to the person. Image 710 is created based on images 702, 704, 706, and 708, as described herein, according to a virtual sensor virtually placed in front of the person, in the middle of the four corner cameras. Image 712, which is captured by a real camera placed right in front of the person, in the middle of the four corner cameras, is very similar to image 710. The similarity between images 710 and 712 indicates the ability to generate virtual images from virtual sensors using data obtained from other sensors located at other locations.

Reference is now made to FIG. 8, which is an exemplary dataflow 802 of training neural networks for processing inputs from sensors, in accordance with some embodiments of the present invention. Sensors 804 are as described herein, for example, cameras and/or microphones, optionally low quality, as described herein. Output of each sensors 804 is fed into a respective neural network, which form a backbone 806. Each output 808 of each neural network of backbone 806 undergoes a transformation 810, for example, conversion into a common geometric system, and minimizing a single function 812 for the multiple neural networks of backbone 806.

Dataflow 802 may be for a generic component for multisensory input to an existing neural network. An inclusive component may be built, that allows planting an existing function or network of neurons as one of many backbones, running them in parallel, uniting them into a common geometric system and minimizing a single function. The component may be trained as a single neural network that transmits the input through the backbones and minimizes the integrating function, bringing to the optimum both the parameters of the backbones and the parameters of the missing geometric transformations. The component may be built as a generic component that is not conditional on the built-in neural network, and may be adapted to several possible types of outputs.

The following are one or more exemplary sub-tasks for implementation:
Calibration/obtaining a known geometric ratio of location and orientation of the various sensors. The system's initial self-calibration capability may be developed.
Development of infrastructure for running multiple backbones neural networks on the inputs of the sensors simultaneously.
The infrastructure may be generic and may be able to support the running of various neural networks such as:
   Video quality improvement network
   Audio quality improvement network.
   Depth network
   Biometric identification network
   Gesture recognition network
   Pupil tracking network
Conversion of the sensors to the coordinate system of the central sensor in accordance with the known/calibrated geometric ratio.
Transforming the backbones results into a common system. The challenge is to perform a parametric transformation in three-dimensional space. The parameters may be extracted in the minimization (optimization) phase that connects the transformations. An error in performing the transformations may lead to distortions in the output, which may be corrected during the minimization phase.
Minimizing the errors between the various converted results in order to arrive at an optimal fusion of the output.
Merging the results from the converted outputs of the various sensors after minimizing the errors to a uniform network output.

At least some embodiments described herein relate to enhancing the user experience in remote conferencing by utilizing multiple input sensors, as opposed to the existing situation where a single input sensor is used. To this end, at least some implementations described herein are a transition from implementing functions based on a single sensor to a state of multiple sensors. This capability makes it possible to break through the glass ceiling of existing capabilities that are based solely on the computational capability of data coming from a single source.

Reference is now made to FIG. 9, which is an exemplary dataflow 902 of training an autoencoder 904 for converting low quality input 906 obtained from one or more sensors into high quality output 908, in accordance with some embodiments of the present invention. For example, for generating a single high quality image and/or audio play from multiple low quality cameras and/or low quality microphones, as described herein. Autoencoder 904 may be trained on a training dataset of low quality input 906 and ground truth high quality input 908. The low quality input 906 may be obtained by degeneration 910 of the high quality input 908, for example, by a degeneration function.

Dataflow 902 relates to a low-quality signal recovery machine learning component, optionally autoencoder 904, reconstruction of a high-quality signal 908 from one or more low quality signals 906. The auto-encoder neural network 904 is trained on the high-quality data 908 and on the artificially degenerate images (i.e., low quality data 906) based on a desired degeneration function 910. The network input is the degenerate image, and the desired output is the high-quality source image. Based on the large number of samples available, the network learns to recover a high quality image signal from an inferior suitable signal. The network learns to correct optical distortions, for example of noisy sensors, of blurring resulting from a point scattering function, and the like. Multiple auto encoders may be trained and implemented, for example, in backbone 806 described with reference to FIG. 8, for using the corrected signal from each sensor and making optimal defragmentation.

The following are one or more exemplary sub-tasks for implementation:
Development of an auto-encoder neural network for training the signal recovery model.
Definition of degeneration functions according to typical scenarios, such as distortion due to optical diffraction, blurring, smearing, low resolution, lighting problems, contrast, etc.
Separate training according to defined types of degeneration.

At least some embodiments described herein relate to correcting severe distortions in source images for example: distortion resulting from optical diffraction. The combination of the autoencoder the generic component of the fusion based on multiple sensors as described with reference to FIG. 8 may be selected and/or used.

Referring now back to 212 of FIG. 2, additional exemplary processing features and/or additional other exemplary features are described:

A multi-sensor depth component based on beam coordination is provided. The component receives as input multiple images (or other sensor data) from multiple visual sensors (or other sensors) that view the same scene in sync (at a given time), and computes a depth map for each pixel in the input images. The component may be trained on images that are produced synthetically from a detailed three-dimensional visual simulation, which enables producing a very large amount of data for effective training.

The following are one or more exemplary sub-tasks for implementation:
Merging inputs to a thin super-lattice in which each image is located based on its location in space for the purpose of building a single input in which the relative location data of each sensor is embedded.
Creating a function that converts position in space to depth for each pixel in the super-lattice. Each point in space is applied to each of the images obtained from the sensors. The function calculates the distance from the photography plane for each position in the lattice.
Construction of a neural network that receives the super-lattice as input and the appropriate depth map as a desired output for the purpose of network training and reaching the required accuracy.
Separate training according to defined types of scenes such as: different sizes of rooms, desks, scenes with multiple participants, etc.

At least some embodiments described herein relate to achieving in-depth images based on multiple sensors through the implementation of ML components. At least some embodiments described herein merge the inputs from two or more sensors. This allows for achieving a video call experience with depth but without compromising performance. At least some embodiments fully synchronize the acquired images while correcting the time differences (as they may be) in capturing the images.

At least some embodiments described herein compute a real-time, multi-dimensional (N-D), and/or directional perception of the captured scene, which may include one or more of the following synchronized representations:
1. An enhanced two-dimensional image of the scene from every chosen perspective within the area of the display monitor, i.e., from any virtual sensor located anywhere within the surface.
2. Depth information for every pixel captured in the scene.
3. Direction vectors pointing every subject's gaze to the area of its focus on the display monitor.
4. An enhanced audio signal from every chosen direction within the area of the display monitor, i.e., from any virtual sensor located anywhere within the surface.
5. Location in the scene of every audio source.
6. Direction vectors and cone angles pointing every audio source to the area of its focus on the display monitor.
7. Time dimension for representations 1-6.

On a higher, abstract level, the multi-dimensional perception is broken down into entities in the scene, for example, subjects, objects, and background. The dynamics of each entity may be extracted. Eventually, subjects' pose, gaze, gesture, and behavior may be classified.

Deep learning may be incorporated into steps of the processing-including signal recovery, signal enhancement, perception reconstruction, gesture recognition, entity separation, and classification of behavior. This allows for self-learning of the local system whenever feedback is available to the system. Furthermore, centralized learning done remotely with data captured locally and annotated on the backend side, may allow for improvement over time of the behavioral pattern understanding. Loop closure with existing personal assistants may enable to feed a broader learning engine with more differentiating signals on local, facility, and overall user levels.

Beyond scene capturing from the grid of sensors and their processing into outbound transmittable information, inbound directional sound may be processed and/or divided on to the embedded speaker grid, so that intensity and/or directionality are preserved in the ears of the user, based on speaker spread and user's scene geometry.

The processor may extract layers of information and/or perform the acceptance of application-specific input through the API.

The main noise components in an image sensor may be dark noise, photons shot noise and/or readout electronic noise. Pinholes are described in greater detail below. Since the limited pinhole size allows a relatively low photon flux per sensor, the dominant noise is expected to be the readout noise, which is generated by the amplifier converting the electrons charge to analog voltage. Note that for CMOS sensors there may be slight variation in the readout noise between the pixels due to their separate electronic circuit. Since the readout noise is independent of the photon flux, SNR may be increased by increasing the photon flux per pixel. Higher photon flux may be achieved with a bigger pinhole; however, the pinhole size is proportional to the optimal focal length, which is limited in order not to increase the device thickness. If a physical pinhole is needed, it may be preferable if the hole is as small as possible to have minimal visual effect on the display.

The other factor directly affecting the SNR is the exposure time. When capture is done simultaneously with the display, the exposure time is limited by the desired frame rate of the captured video. However, when there is a need to toggle between the two modes, the frame rate may be double the refresh rate to avoid flicker effect in the display, which is at least 120 Hertz (Hz), meaning exposure time shorter than 8 milliseconds (ms). Since this frame rate is much faster than needed for the video itself, the SNR could be improved by averaging frames up to the desired frame rate. Note that the SNR improvement is only a square root of the number of averaged frames.

Image blur is a common problem that occurs when recording images. Major blurs are attributed to either motion-due to camera shake, long exposure time, or movement of objects—or optical ray de-focus. Pinhole cameras produce blurred images due to light diffraction, as is the case when the size of the pinhole is too small. As a result, the recorded image is degraded, and the captured scene becomes unreadable. The process of removing blurring artifacts from an image is referenced as deblurring. The problem is known as blind deconvolution if the only available information is the blurred image and there is no knowledge about the blurring model, or the point spread function (PSF). The blurring process can be modeled with the following equation:

$$g ( x , y ) = f ( x , y ) * h\_psf ( x , y )$$

where g denotes the blurred image, h denotes the point spread function and f denotes the deblurred image.

This problem may be solved using Inverse filter approach in the frequency domain, however with the presence of noise, resulted deblurred image may contain a significant amount of noise. A better fitted approach for this case may be the minimum mean square error filtering (Wiener) which also considers the power spectrum of the noise in addition to the power spectrum of the degraded image resulting in a better SNR and a deblurred image.

The deblurring process is calculated for each sensor separately with a mathematical model of the PSF. The PSF may also be measured as part of a sensor calibration process. In the case of a measured or modelled PSF, it can be used as part of the deblurred image estimation.

The sensor arrays may include multiple sensors in a pre-defined grid structure. Information between sensors may be combined. For example, output of multiple 2D image sensors are computed to reconstruct the 3D information of the scene. The information of multiple sensors viewing the same object may be combined to increase the signal and/or reduce the noise appearing in each image separately. Such features may be in addition to, and/or alternatively to, computing the virtual sensor dataset from the data captured by the sensor array.

Different pixels in different sensors correspond to the same object in real world. By summing all the pixel values that correspond to the same object point, new image of the object on which the signal to noise ratio is much stronger than any of the individual sensors, may be obtained. Pixels that correspond to the same blobs are identified. The process of finding blobs and summing the corresponding pixels can be repeated many times. In each iteration the SNR improvement allows for a more accurate blob detection, which allows iteratively finding more accurate corresponding pixels.

Image processing techniques such as simple thresholding, Otsu method, graph cut and neural networks may be used for detecting blobs from datasets of individual image sensors. Features are extracted from each blob. The features are used to match blobs that represent the same object in the real world.

Blobs of known objects such as faces, humans, eyes, and other human body parts, may be detected. This detection may be made by trained classifiers or neural networks.

After detecting and matching blobs from various sensors, the 3D location of the blob in real world may be found, for example, by using triangulation. Each blob in each sensor represents a ray in 3D. The intersection of those rays indicates the 3D location of the blob. To avoid outliers, after the 3D reconstruction rays that are far-away from the 3D point may be removed (using a predefined threshold). The process may be repeated.

Having the 3D location of the blob allows calculating the homography between each sensor pairs in the blob neighborhood. Homography is defined as a linear transformation that projects 2D pixel location in one image sensor to a different 2D location in another sensor, such that both locations correspond to the same 3D object in real world.

Having the homographies between image pairs allows projecting the image from each sensor, one on the other. By projecting many images one on the others, by taking the mean of many projected images the SNR is increased. Increasing the SNR results in better deconvolution (aka deblurring), and better blob detection. The process of blob detection->calculating homographies->denoise->deblur can be iterated, where each iteration results in better blobs, leading to more accurate homographies, better denoising and deconvolution.

Neighboring signals may contain similar geometrical data that can be fused together to produce higher detailed resolution image. A condition for any super resolution technique to be successful may be the presence of high frequencies embedded in the low-resolution image. These may be the result of an aliased sampling process.

The super resolution technique described herein exploits the sub pixel shift between the neighboring signals to produce higher resolution image. Moreover, in case the objects' presence is far from the screen it is reasonable to assume that the differences between neighboring signals are only shifts.

The described herein can be expanded to as many neighboring signals as needed. First phase is creating a high-resolution image grid where all signals will be projected to. To simplify computation one sensor may be set as the high-resolution grid and may be resized accordingly with no additional signal information. To clarify, at this point a higher resolution grid of the chosen sensor with mostly “holes” for missing data is obtained. As a second phase, each of the chosen neighboring signals is projected into that high resolution grid. The projection matrices are calculated based on the reconstructed depth information, designed shifts between the sensors and the known optics. Once the projections are completed, a full higher resolution grid is established. As the final phase a high-resolution grid quantization may be applied, for example, using an interpolation method. This also allows for some small “holes”, in case present, to be “filled” in the final high-resolution image. At the end of this super resolution process, a high-resolution, cleaner image is obtained for each of the signals that were used.

By increasing the SNR and applying deblurring, the quality of the images is improved to a level that allows performing dense depth reconstruction. Feature approaches such as SIFT, SURF, BRISK, etc. and/or image techniques such as Bundle Adjustment and/or ray triangulation may be used to obtain dense 3D representation of the scene.

Gaze tracking may be performed, for example, using neural networks that were trained for this task. Gaze recovery can take advantage of the multiple image sensors of the sensor array. Gaze tracking may be applied to each sensor and/or the results from multiple sensors may be combined to obtain more accurate gaze tracking. More weight may be assigned to the sensor that is aimed directly to the person gaze, while may be a virtual sensor.

Various applications may take advantage of the ability to perform track gaze, for example, allowing the user to interact with the software using only his or her gaze.

Implementations described herein improve upon gesture recognition from 2D and 3D, where temporal sensing is commonplace. The richer the data, the easier it is for an algorithm to recognize the gesture. Full body gestures that include finger, hand, head, as well as leg and whole-skeleton temporal signatures are captured and labelled for a learning classifier. The improvement obtained by at least some embodiments described herein is based on the fact that the captured data is as rich as the multi-dimensional perception extracted from the sensor array, and so any training on that data would rely on the grid setup. Special attention may be given to generalizing the trained NN to changes in the geometry of sensor arrays that is different between interaction devices such as display monitors.

Similar to the case of visual sensors, the quality of the signal generated by an audio sensor is proportional to the size of the membrane absorbing the sound waves in the air. Fiber-optic, piezoelectric or microelectromechanical systems (MEMS) microphones allow for very small absorbing areas, down to sub-millimeter diameter sizes, to produce signals with high fidelity.

Smaller sensing membranes lead to degraded signals, and some pitches may be distorted compared to others. The smaller the aperture allowing the sound waves to pass, the bigger the effect on the spectrum of frequencies.

Raw signals of the individual sound sensor may require initial processing to reduce noise and to cancel distortions attributed to the known and calibrated slit size.

The combination of individual signals from the different sensors in the grid enables to regain the high fidelity in the resulting signal. This enhancement may include noise reduction, and/or improved separation of interfering frequencies. Moreover, due to the wide spread of the sensors across the area of the display, directionality of the sound source, and/or the separation of different sound sources, when several of those exist, may be reconstructed.

The amplitude of the enhanced signal may be regained by a summation of the amplitudes of corresponding frequencies. Frequencies that are too weak to reach some of the sensors may be recovered from those sensors that did pick them up, while phase and angular differences between sensors ensure that the multi-sampling process captures the full spectrum of the original sound wave.

The 3D nature of the sound capture enabled by the sensor array may allow for spatial recovery of the sound sources and their directionality properties. This enables reproducing the richness of the audio experience, given the means to convert those back to sound waves, for example, given an equivalent grid of speakers. Principles of such rich sound reproduction may be based on approaches used for recording and playing of surround sound. A rich audio capture of the space in front of an interactive display device may be used in the reconstruction of the multi-dimensional perception, leading to improved comprehension of gestures and typical behaviors.

After enhancing the audio signals of each one of the sensors in the grid, based on the combination of signals from the rest of the sensors, principal vectors of the sound cones may be estimated from the changes in amplitude and phase. The equations of spatial reconstruction of source locations from directionality may be parallel to those used for vector intersection in space used in stereographic 3D mapping.

Biometric identification may involve subsets of descriptors from the multi-dimensional perception that are used to uniquely ensure the recognition of identity of a subject, to an extremely high level of accuracy.

The N-D signature described herein, that includes temporal as well as implicit unique features, allow it to be safe enough for the strictest of applications. Privacy preservation may be embedded to an API exposing information to the external world.

The processor receives video and/or audio streams from the sensor array located on the common surface. The processor orders the streams into coherent images and/or sound signal sets per epoch, that may be processed to extract knowledge about the scene. The processor may compute the virtual sensor datasets from the streams obtained from the sensor array, as described herein.

The processor may be modular, the main building blocks being a visual processor, a sound processor, and/or an integrator. The visual processor may be responsible for creating high-resolution improved images for each epoch, given the set of sensor images, and/or extracting all the visual information gathered about the scene. The visual processor may include, for example, a data grabber, a single-sensor processor, and an image-set processor, as components.

The data grabber component receives video inputs, synchronizes the videos, and outputs an image set per epoch. The single-sensor processor may carry out the noise reduction of a single image. The single-sensor process may detect changes and/or moving objects, calculate the homography between the image and other images, and/or project the reconstructed 3D scene back to the sensor.

The image-set processor may carry out iterations of depth estimation and/or super-resolution using the data from all cameras. The image-set processor may divide the scene to background, objects, and subjects, carry out face recognition and/or estimate the pose and/or gaze direction of each subject.

The integrator may integrate the visual and/or sound data into a complete understanding of the scene.

The following are exemplary steps to separate the scene into subjects, objects, and background:
1. Change detection-compare each single image to the previous images to detect changes over time per sensor.
2. Integrate the segmentation of dynamic areas from all sensors to increase segmentation accuracy.
3. Separate the foreground into various objects, based on the data from multiple sensors, combined with the depth estimation.
4. Detect people figures among the foreground objects.
5. Detect familiar faces by running face recognition on the combination of depth, improved images data of detected faces, and sound signals.
6. Classify the rest of the objects, using the combination of depth data, sensors, and/or sound signals from multiple sensors.

Furthermore, planes may be detected in the background and the background is separated into objects. This takes place, for example:
At system initiation.
After the system understands that the interaction device has moved.
When parts of what was classified as background is changing.
Regularly once a day/a week.

The scene may be repeated segmented into static and dynamic entities. At each epoch, the data of the previous frames' separation may be combined with the change detection that runs on each sensor separately and/or with the depth estimation per pixel, to form an accurate detection and/or segmentation of the dynamic parts of the scene.

Various layers of data may be available per epoch and/or may be accessed via the API. At the highest level, details on habits and behavior of the users may be stored. At the next level, data includes the scene understanding per epoch—the subjects and the actions that they are performing, including names, in case they were recognized. Beneath that the data may include the history per subject and/or object, their track, and/or for the subjects among them the poses and/or gaze direction. The lowest data layer may hold the raw data—the various images and/or sound signals per epoch, including the depth information, segmentation, and/or classification per pixel.

The layered abstraction of data allows each application connecting the processor to get the desired data, according to its needs and/or privilege level.

Learning the subject's pose, gaze, gesture, and/or behavior may enhance the human-screen interaction and/or may add an extraordinary user experience. A user could interact with the screen, for example, via hand gestures and/or gaze. The viewing representation may be updated according to the user's gaze, pose and/or behavior. An AI platform, for example, a neural network, may be used for the classification problem. Following privacy policies, the technology may be capable of self-learning, using the scene and/or subject behavior and/or gestures for later learning. This may allow for further improvements.

The image enhancement process may be performed in an iterative manner. First, noise is decreased using temporal and/or spatial integration. Second, a deblurring by deconvolution is done on each of the signals separately. At this point, the signal may be strong enough to enable an initial face recognition. As a result, a coarse understanding of foreground and/or background is established, and depth may be computed from the foreground blob. Following the initial blob's depth computation homographies are computed for each blob signal and multiple sensors are fused together to create a reduced noise and high-resolution image. This process may be repeated until finer depth maps are formed. Once a foreground mask is extracted, the noise reduction-detection process may be specified to the foreground area alone which may yield an improved signal with no or reduced mixed errors from background or scene. Since less computation is needed, this increases run time efficiency.

The separation of foreground and/or background into objects and/or the gesture recognition may use depth estimation of the subjects as input to classify each pixel. Behavior classification may be again done through a LSTM network that uses the current and previous pose estimations.

The interaction device described herein may include an embedding of an array of micro-speakers, for example, into the display monitor, as part of enabling two-way transmission of video and/or audio signals through the evolving interaction device. Audio signal processing may require special care. The reproduction of the original sound experience relies on the capturing and/or the playing processes of the audio signals. The processor may enable the synchronized acquisition of the sound signals, and may be responsible to include the geometry of the capturing grid, such that a decoder is able to reconstruct the experience even if the speaker grid has a different geometry.

The transformation between sensor arrays of different geometries may be designed such that the preservation of the experience is maintained to the highest level feasible, through an optimization process. The preservation equation may simulate the experience such that the location of the recipient is at the location of the interaction device within the space of acquisition. The location of the receiving subject with respect to its own interaction device may be considered in that simulation.

An API interface, for example, of the processor of the computing device is now described.

The API may expose all available services offered by the processor. Those services may include queries at different levels, for example, a perception level, a scene level, and a subject level. At the perception level, for example, an application may query the pixel data of the enhanced image for any sensor on the array. It may as well query the depth map of the captured space, and/or the location of sound sources within that space.

Similarly, at the scene level, queries may be, for example, about the number of subjects in the scene, the speed of motion of each one of them, and/or the 3D map of the separated background. At the subject level, queries may vary, for example, from pose, gesture, and/or behavior pattern to biometric identifiers of any captured subject.

For every level of information exposure, privacy awareness may be part of the handshake between the calling application and the processor. In addition, the OS-specific driver enabling the inbound and/or outbound communication of the application with the processor, may be programmed to warn a user proactively of the risk taken in enabling the exposure of private information. A decision may be made whether the servicing of private information will halt until an active acceptance has been made by the user.

The API allows for application-specific input to be sent from the application to the processor. Such input may include inbound directional audio signals, requests to control an additional lighting source (as in the case of an IR illumination source added on for improved visibility in low-light scenarios), requests to control the pixels of the display monitor, and/or application-specific constraints on the information transmitted back to the application, for purposes of speeding up or improving detection and tracking robustness.

Furthermore, applications related to personal assistants or smart facilities shall be able to assign triggers on the processor, that would activate a callback function upon pre-defined events. Such events can be as simple as the detection of motion in the scene, or they can be more complex ones, relating to a specific gesture of a specific subject.

An additional implementation within the processor may be the awareness for neighboring devices. For example, a processor installed on one interaction device (e.g., display monitor) may communicate with another processor installed on interaction device (e.g., another display monitor) on the same local network. That communication may be primarily meant for the enablement of a facility level behavioral pattern learning. Multiple processing functions related to the facility level may be enabled within the computing power of the single processor. On the behavioral level tracking may be managed centrally on a server, preferably on a cloud, the larger the burden that can be overloaded on the local processor the better. On a user level, for instance, a central, cloud-based server would have to take over the management of pattern understanding, since a user is not limited to the bounds of a specific facility.

Additional exemplary details on the sensors array on a common surface, optionally sensors within a display (e.g., interaction device) are now described.

The interaction device described herein is based on audio and video sensors integrated into display monitors that provide a tight level of integration. For an ultimate interaction experience, which includes real eye contact, visual sensing may take place at the point the user focuses his or her sight on. In other words, visual capturing may happen from ‘behind’ the screen. The virtual sensor dataset is based on the visual capture by the sensors located within and/or behind the screen.

To avoid interrupting to the main purpose of a display monitor-projecting an ultimate video signal-sensors integrated into the monitor either see-through the layers and/or are small enough to stay invisible. A tiny pinhole, for example, may have the size of about 100 micrometers or less, to be unnoticed. The exact size is dependent on the size of the monitor and its modus operandi.

Moreover, complete gaze tracking that would allow an operating system (OS) to move the focus between application windows automatically, based on recognizing the user's gaze, or would allow a video conference application to create direct eye contact between the user and the specific person he or she is looking at, requires more than one visual sensor to be embedded into the display monitor. As described herein, the virtual sensor dataset of the virtual sensor created based on outputs of multiple real sensors (e.g., cameras) may be analyzed to determine gaze.

The use of multiple sensors for purposes of gaze tracking, depth sensing, and/or redundancy for operation robustness, also address the technical difficulty to receive an appropriate signal from a single sensor that is hidden within or behind the layers of the monitor. A grid of sensors embedded into the surface of a display monitor may be provided.

A processing chip, responsible for receiving video and/or audio signals from an array of sensors, may be provided. The processing chip combines the signals into one or more virtual sensors datasets, and/or into a coherent, high-quality, real-time perception with depth information and/or true gaze tracking. The separation of a subject in this multi-dimensional perception from its surrounding background may be used, for example, for protection of privacy. The processing chip may ensure the separation of the surroundings which may be integral to the formation of the perception itself.

The built-in capability to separate objects in the captured space may be used for grasping the biometric characteristics of users, and/or for example for virtual reality and/or gaming applications. The processing chip may perform one or more of the following features:
Synchronizing the multiple raw video and/or audio signals, combining them into a real-time, multi-dimensional, directional perception.
Computing one or more virtual sensor datasets for one or more virtual sensors based on the real sensors located within the common surface, as described herein.
Separating subjects and scene elements.
Capturing biometric characteristics of identified vs. non-identified users.
Tracking gaze and sound directionality in real-time and highlighting the sensor of user's focus.
Learning and inferring gestures and habits on local level.
Learning and inferring behavioral patterns on facility level and on overall user level.
Exporting real-time directional audio input on to embedded speaker grid.
Extracting layers of information and/or accepting application-specific input through an application programing interface.

An open API may be provided to enable multiple different applications in different domains, for example, gaming, fashion shopping, fitness, biometric identification, group conferences, gaze-based UI, education, active monitoring, and/or behavioral pattern tracking.

The interaction device implemented as a display described herein may be implemented using different display monitor technologies, for example, LED-backlit liquid crystal displays, organic LED, and/or micro-LED displays. The array of sensors may include a grid of sensors that are invisible on one hand, and capable of receiving an appropriate photon flow on the other.

The interaction device implemented as a display described herein may be implemented, for example, using 3 main display monitor technologies that are used for various applications, from smartphones to large-screen TVs: LCD (liquid crystal displays), OLED (organic light-emitting diodes) and micro-LED (μLED) displays. These technologies and their technical challenges and/or advantages to the integration of sensors behind the monitor, is now described.

In LCD, the light passes through a layer of molecules whose polarization is controlled by the voltage applied to each pixel. The liquid crystal (LC) layer is placed between two polarizing films with perpendicular polarization state, and the voltage change controls the light transmission through the pixel. Since the LC does not generate light but only controls its transmission, these displays require a backlight illumination component. Backlight technology is based on light emitting diodes (LEDs), which replaced the older technology of CCFL (cold-cathode fluorescent lamp). The LEDs are placed either on the edge of the monitor or as an array behind it, with new displays utilizing mini-LEDs for denser arrays that allow local control of the illumination level and improved contrast. Both types of backlight implementation require placement of diffusion films between the backlight and the LCD components for homogenous illumination. Edge illumination also requires a light guide panel.

OLED is an emerging display technology, gaining momentum for both small and large monitors. In this technology, light is generated by an organic layer placed between two electrodes. Since the pixels themselves emit the light there is no need for backlight, allowing for thin devices with high dynamic ratio, improved color contrast and low power consumption. The drawback of OLED is the phosphor decay, causing a shorter lifespan and luminance instability, especially under conditions of direct sunlight or when static images are displayed. New transparent OLEDs reach current transmissivity in the range of 30-40%, and continuous efforts to increase it exist.

The most recent emerging technology is μLED displays. Like OLEDs, the pixels are actively emitting the light, but in this configuration, they are composed of micron-size LEDs instead of organic material. This technology offers the benefits of OLED with higher brightness and without the instability and decay problems associated with the OLED. However, it is still mostly in R&D phase and though there are transparent μLED displays available, with even higher transmissivity, they are more expensive than their OLED counterparts. Still, this is a promising technology that is expected to mature in the coming years.

Integrating a sensor grid in an LCD has a unique technical challenge due to the presence of the backlight component behind the display. A video sensor cannot be placed behind the diffusion films which would blur the incoming image. Also, an image cannot be captured while the backlight is on, due to saturation of the sensor. Embodiments described herein are designed to overcome these technical constraints for LCD technology by placing dedicated pinholes in the diffusion films. The backlight saturation might be mitigated by toggling between capture and display modes at a high frame rate exceeding the visual refresh rate to avoid display flickering. The LCD pixels can transfer light to the sensors when they are in the “on” state and the backlight is turned off. However, it should be noted that this configuration would limit the exposure time thus reducing the signal to noise.

The lack of backlight makes the integration of sensors easier compared to LCD. Recent developments of transparent OLEDs with relatively high transmission removes the need to place any mechanical holes in the screen and allows to use the pixels themselves as both light emitters in display mode and pinholes for visual sensors when the pixels are in “off” state. If a non-transparent display is to be used, a pinhole for the sensor is placed in the cathode, for example, during the display manufacturing process. Image capture may be done simultaneously with display, depending on the directionality of the OLED pixel emission and/or the amount of light from neighboring pixels that might leak into the pixel (or pixels) designated as a pinhole for the sensor may be considered and/or accounted for.

The main difference between OLED and μLED is the composition of the light-emitting pixel, however the operation principle is similar and both options lack a backlight component, and the light is generated by the pixels themselves. Therefore, the challenges and advantages for sensors embedding are quite similar. Transparent u LED might offer higher transmission compared to OLED. Non-transparent display may require drilling a physical pinhole in the display; however, it might be a simpler procedure than in OLED.

Most cameras include a lens to focus the incoming light onto the sensor. Moreover, embedding a sensor grid in the display itself imposes a constraint on the focal length, especially when new displays are becoming thinner. Therefore, at least some implementation described herein consider two options—with and without lens, the latter being a pinhole camera configuration.

For a pinhole configuration, the pinhole can be a single pixel (or a few neighboring pixels), switched to a state where it lets the light pass through (“on” state for LCD, “off” for OLED or μLED). Another option is placing a physical hole between the pixels. Either way, if the image capture should take place simultaneously with the display, the pinhole size is limited to about the size of a single pixel, to avoid visible interference to the display. In case of toggling between capture and display mode, the pinhole can be bigger if desired.

The light passing through the pinhole is going through diffraction, which blurs the image and reduces the spatial resolution. The point spread function (PSF) for a circular pinhole is an airy function. Smaller pinhole yields a higher resolution close to the pinhole, but a stronger diffraction effect. The approximate optimal distance between the pinhole and the sensor (the focal length f) is given by f=r²/λ, r being the pinhole radius and λ the optical wavelength. It should be considered that the diffraction effect is stronger for the red colors (longer wavelengths) compared to the blue. If the screen thickness cannot exceed about 1 cm, the pinhole diameter should be no bigger than 150 μm, a constraint that aligns with typical pixel size in large displays. The relatively small pinhole limits the number of photons reaching the sensor, thus reducing the signal-to-noise ratio (SNR). However, the sensors grid and additional image processing can be utilized to partly compensate for the lower SNR and improve the image resolution.

Using a lens is preferable to achieve higher resolution and SNR by focusing the incoming light. However, the limited focal length does not allow placement of wide-field standard lenses. There are options for folded-optics imaging, achieving longer actual focal length at a smaller thickness, which might be considered for this application. It should be noted that lenses could be considered only when there is no backlight component, since they will distort the illumination. Therefore, this option is applicable for OLED or μLED. Another option that could be considered are lenses embedded in the display itself and placed in the junctions between pixels. However, the limitation on focal length might limit their field of view to short-range applications.

CCD (charge coupled device) and CMOS (complementary metal oxide semiconductor) image sensors are two different technologies for capturing images digitally. The main difference is the conversion of the pixels' charge to voltage. CCDs include several transistors and an analog-to-digital (AND) converter for the whole array, while in CMOS there is a dedicated transistor for each pixel. For the discussed application, CMOS sensors offer lower read-out noise, which is the dominant noise for low photon flux, higher quantum efficiency and higher frame rate, which may be important if the implementation toggles between capture and display mode. On the other hand, CCDs often have A\D conversion to more bits and allow easy on-chip binning of pixels to increase sensitivity, which is limited in CMOS due to the separate electronics per pixel. Though CMOS seems like a better fit for at least some embodiments described herein, the variety of options in each category makes both technologies viable candidates.

A wider pinhole and a longer exposure would both increase the photon flux. In addition, if the pinhole is the pixel itself and not a physical hole in the display, the flux is proportional to the transmissivity of the transparent or semi-transparent display. A wider pinhole may be preferable to reduce the diffraction effect, since stronger diffraction spreads the light on a larger area of the sensor, thus reducing the photon flux. Since both the pinhole size and the exposure time are limited, so is the photon flux, and other methods can be used to mitigate the lower SNR.

An example design of a sensor grid covers the full span of the display at uniform distances, with spacing that guarantees that the light passed through each pinhole should be imaged only on the sensor in front of that pinhole to avoid interference between the sensors. The grid design is affected by the approximate distance of the imaged targets. Though a pinhole camera has in principle an infinite field of view, in practice a closer target will be imaged over a larger portion of the sensor compared to the same size target located further away from the display (assuming the same focal length). Therefore, the sensors size, grid spacing, and focal length should be set so that the closest targets can be fully imaged on a single sensor and the spatial resolution of the farthest targets is still sufficient.

The sensors do not necessarily have to be uniformly spread and other geometries may be considered. The sensors may be tilted so that different sections of sensors will focus on different parts of the surrounding. Any deviation from a grid is incorporated into the post image processing.

With respect to mechanical design and/or sensor wiring considerations, an example implementation is to use a transparent OLED or μLED monitor, where the display electronics and ports are located on the edge of the screen and not behind it, leaving the backside of the monitor free for the sensors grid. In this configuration, an opaque panel with designated pinholes can be placed directly behind the transparent monitor, each pinhole aligned with one of the monitor's pixels. The sensors array can be placed at the required focal distance with the sensors aligned with the pinholes. To capture an image, the pixels in front of the pinholes should be turned off to allow the light to pass through to the sensors. If capture can be done simultaneously with display, the other pixels can still operate in the normal display mode, and the sacrifice of a few individual pixels should not have significant visual effect. The outputs of all sensors is connected to a processor, attempting to minimize the thickness added to the device. The processor may be placed in the gap between the monitor and the sensor array (the focal distance) without blocking any of the sensors.

For a non-transparent monitor without backlight component, the sensors configuration can be similar, however the pinhole may be physically placed either at the junction between pixels or by sacrificing some of the pixels. It is preferable, especially for OLED monitors, that the pinholes are placed during the manufacturing process since any drilling in the complete monitor might damage the display. A presence of backlight component, in the case of LCD displays, complicates the implementation, and requires placing the sensors grid behind the backlight and placing designated pinholes in the diffusion films. If the backlight illumination is placed on the monitor edge, the light guide should also be modified to allow light transmission to each sensor.

Simultaneous image capture and display might be challenging due to light leaking from the neighboring displaying pixels into the pinhole pixel. However, toggling between capture and display modes significantly limits the exposure time thus reduces the SNR. One option to enhance photon flux and increase SNR is to use the near-IR optical range for image capture as well, while the display is limited only to the visible range and does not overlap. The sensor acquires the near-IR range at all times, and acquires the full optical range when the display is turned off. This implementation requires an IR-sensitive sensor. Band-pass filter post-processing might be sufficient if the display leakage in the visible range is not fully saturating the sensor. Otherwise, a tunable band-pass optical filter might be used to implement this option.

The incorporation of LiDAR sensors and/or any lens-based cameras in the casing of the display monitor may enrich the captured data. Calibration of such auxiliary sensors may be part of the calibration process taking place in the initiation of every display monitor, and may be performed on the processing chip. Similar care is taken in any follow-up, periodical calibration intended to ensure the geometry of the sensors has not changed.

LiDAR data, optionally in the form of four-dimensional point clouds, may be added to the N-D perception generated by the sensor array, while differences in the temporal resolution of the various sensors is being resolved by proper resampling.

Additional exemplary embodiments are now described. The exemplary embodiments include features and/or components that may be integrated with, combined with, added to, and/or substitute, one or more features and/or components described with reference to FIGS. 1-13. For example, the display monitor described herein may include the sensor array on common surface (i.e., interaction device) described herein. In another example, circuitry may be implemented as the processor that processes datasets obtained from the sensors of the sensor array on common surface.

In some embodiments, a display monitor comprises: a screen comprising an array of pixels,
a plurality of imaging sensors arranged in a grid located behind and/or within the screen, the plurality of imaging sensors being spaced part and distributed across a width and length of the screen, wherein a plurality of pixels are disposed between spaced apart imaging sensors, each imaging sensor sized and adapted for outputting a respective compromised quality dataset depicting a partial field of view, and processing circuitry integrated within the display monitor, the processing circuitry configured for obtaining the compromised quality datasets outputted by the plurality of imaging sensors, stitching the datasets into a main image at higher quality that depicts a full field of view, and providing the main image as output.

Optionally, the screen comprises a plurality of pinholes corresponding to the location of the plurality of imaging sensors arranged in the grid, wherein each single pinhole corresponds to each single imaging sensor.

Optionally, the spacing of the grid of the plurality of imaging sensors is selected such that light passing through each respective pinhole is imaged only on the respective imaging sensor behind the respective pinhole and not imaged by other imaging sensors, for avoiding interference between imaging sensors.

Optionally, a combination of the spacing of the grid of the plurality of imaging sensors, a size of each respective imaging sensor, and a focal length of each respective imaging sensor, is selected such that closest targets are fully imaged on a single imaging sensor and a spatial resolution of farthest targets is sufficient for imaging.

Optionally, the size of each single pinhole is at least one of: (i) about 50-200 micrometers when a thickness of the screen is about 1-3 centimeter.

Optionally, the size of each single pinhole corresponds to a size of less than 1 screen pixel to 10 individual screen pixels.

Optionally, the screen is implemented as a liquid crystal display (LCD) with light emitting diodes (LEDs) as a backlight illumination element, wherein the plurality of pinholes are physical holes located in diffusion films located between the LED and the LCD, wherein the pinholes exclude lenses.

Optionally, further comprising circuitry configured to toggle between image capture mode of the plurality of imaging sensors when a backlight illumination is turned off and the screen pixels are passing incoming light through to the imaging sensors, and a display mode of the screen pixels when the plurality of imaging sensors are “off”, at a high frame rate that exceeds a visual refresh rate.

Optionally, further comprising circuitry configured to set the imaging sensors to acquire near infra-red (IR) range images during an image capture mode and during a display mode, and set the imaging sensors to further acquire full optical range images during the image capture mode.

Optionally, the imaging sensors include IR-sensitive sensors, and further comprising circuitry configured to perform a band-pass filter post-processing and/or further comprising a tunable band-pass optical filter.

Optionally, a frame rate is about double the visual refresh rate for reducing or avoiding flicker effect in the display, wherein the frame rate is at least 120 Hertz (Hz) and wherein exposure time is shorter than about 8 millisecond.

Optionally, the screen is implemented as one of: organic light emitting diodes (OLED) and micro-LED display (uLED), wherein the pixels are transparent to light when not in display mode, wherein the plurality of imaging sensors are located behind the pixels, wherein pixels transparent to light located in front of respective imaging sensors act as respective virtual pinholes.

Optionally, further comprising circuitry configured to toggle between (i) a capture mode of the plurality of imaging sensors and an “off” state of the pixels, and (ii) a display mode of the pixels and an “off” state of the imaging sensors.

Optionally, display electronics and ports are located on an edge of the screen, wherein the grid of the plurality of sensors is located behind the screen, further comprising an opaque panel with a plurality of physical pinholes positioned behind the transparent screen and in front of the grid, wherein the grid of the plurality of sensors is positioned at respective focal distances for respective sensors and respective pinholes are aligned with respective pixels.

Optionally, the plurality of imaging sensors are in a capture mode while simultaneously pixels in front of the pinholes are turned off to allow light to pass through to the imaging sensors, while simultaneously other pixels not located in front of the pinholes are in a display mode.

Optionally, the screen is implemented as at least one of: OLED and μLED, wherein the pixels are non-transparent to light, wherein the plurality of pinholes are physical holes in the screen located between pixels and/or replacing pixels.

Optionally, the plurality of imaging sensors are in a capture mode simultaneously with the pixels being in a display mode.

Optionally, further comprising a respective lens positioned relative to each respective pinhole.

Optionally, a first group of sensors is located behind pinholes and wherein a second group of sensors is located behind lenses.

Optionally, the plurality of imaging sensors further include LiDAR sensors that acquire four-dimensional point clouds.

In some embodiments, an apparatus for generating images, comprises: processing circuitry configured for: accessing a plurality of compromised quality datasets each depicting a partial field of view outputted by a plurality of imaging sensors arranged in a grid located behind and/or within a screen of an array of pixels, the plurality of imaging sensors being spaced part and distributed across a width and length of the screen, wherein a plurality of pixels are disposed between spaced apart imaging sensors, and stitching the plurality of compromised quality datasets into a main image and processing the plurality of compromised quality datasets for increasing the signal-to-noise ratio (SNR) of the main image relative to the SNR of individual compromised quality datasets.

Optionally, a frame rate is about double a visual refresh rate for reducing or avoiding flicker effect in the display, and wherein the processor is further configured for averaging frames up to a desired frame rate for improving signal to noise ratio.

Optionally, the processing circuitry is further configured for performing spatial averaging of neighboring pixels for improving SNR of the main image relative to the SNR of the individual compromised quality datasets.

Optionally, the processing circuitry is further configured for performing a deblurring process for each imaging sensor separately with a mathematical model of a point spread function (PSF) attribute of optics of respective imaging sensors.

Optionally, the deblurring process is computed based on a minimum mean square error filtering process that receives as input: a power spectrum of a blurred noisy compromised quality dataset obtained from the respective sensor, and the PSF.

Optionally, different compromised quality datasets of different imaging sensors correspond to a same object located in front of the screen, wherein the processing circuitry is further configured for: computing the main image of the same object by summing and/or averaging values of pixels of the different compromised quality datasets that correspond to the same object.

Optionally, the processing circuitry is further configured for: iteratively finding pixels of compromised quality datasets of imaging sensors corresponding to a same blob, and summing corresponding pixels of compromised quality datasets of the same blob, wherein in each iteration SNR is improved for increasing accuracy of blob detection which increases accuracy of finding pixels of the different compromised quality datasets corresponding to the same blob.

Optionally, the processing circuitry is further configured for: processing each compromised quality dataset of each image sensor to detect each respective blob, extracting features from each blob, matching blobs using features representing a same object, and detecting blobs of known objects.

Optionally, each respective detected blob depicted in each compromised quality dataset of each sensor represents a respective ray in 3D, wherein the processing circuitry is further configured for: computing, for each respective detected blob, a respective intersection of respective rays by triangulation, wherein the respective intersection denotes a respective 3D location of the respective detected blob.

Optionally, the processing circuitry is further configured for: removing rays that are located a distance from each respective 3D location that is greater than a threshold for removing outliers, and iterating the computing of the respective 3D location.

Optionally, the processing circuitry is further configured for computing homography between respective pairs of imaging sensors in a respective neighborhood of each respective detected blob, wherein homography denotes a linear transform that projects a first 2D pixel location of a first compromised quality dataset of a first image sensor to a second 2D location in a second compromised quality dataset of a second imaging sensor, such that the first 2D pixel location and a second 2D pixel location correspond to a same 3D object.

Optionally, the processing circuitry is further configured for projecting a certain compromised quality dataset of a certain image sensor to another compromised quality dataset of another image sensor using the homography computed for a pair of the certain and the another image sensors, and iterating the projecting for different compromised quality datasets of different pairs of image sensors, for increasing the SNR of the main image and better deblurring of the main image.

Optionally, the processing circuitry is further configured for iterating the detection of blobs, computing the homography, the projecting for increasing the SNR, and the deblurring.

In some embodiments, an apparatus for generating images, comprising: processing circuitry configured for: accessing a plurality of compromised quality datasets each depicting a partial field of view outputted by a plurality of imaging sensors arranged in a grid located behind and/or within a screen of an array of pixels, the plurality of imaging sensors being spaced part and distributed across a width and length of the screen, wherein a plurality of pixels are disposed between spaced apart imaging sensors, and stitching the plurality of compromised quality datasets into a main image and processing the plurality of compromised quality dataset for increasing resolution of the main image depicting a full field of view.

Optionally, the processing circuitry is further configured for: creating a high resolution image grid where compromised quality datasets of neighboring image sensors are projected to, computing projection matrices based on reconstructed depth information, designed shifts between the imaging sensors, and known optics of the imaging sensors, projecting each of a plurality of selected neighboring compromised quality datasets into the high resolution grid to obtain a higher resolution grid, and applying a high-resolution grid quantization using an interpolation approach for “filling” in some small “holes” in the higher resolution grid to obtain a final high resolution image.

Optionally, the processing circuitry is further configured for: fusing neighboring compromised quality datasets that depict similar geometrical data to generate a higher detailed resolution image.

In some embodiments, an apparatus for generating captured images, comprising: processing circuitry configured for: analyzing a main image that is at a high resolution and depicts a full field of view, computed from a plurality of compromised quality datasets each depicting a partial field of view, wherein the SNR of the main image is higher than the SNR of individual compromised quality datasets, the plurality of compromised quality datasets outputted by a plurality of imaging sensors arranged in a grid located behind and/or within a screen of an array of pixels, the plurality of imaging sensors being spaced part and distributed across a width and length of the screen, wherein a plurality of pixels are disposed between spaced apart imaging sensors, and generating a dataset for the main image based on the analysis.

Optionally, analyzing comprises performing a dense depth reconstruction, and the dataset comprises a dense 3D representation of a scene.

Optionally, analyzing comprises feeding the main image into a machine learning model that generates an outcome of a recognized face, wherein the dataset comprises the recognized face.

Optionally, the processing circuitry is further configured for feeding each of a plurality of compromised quality datasets into a machine learning model generates an outcome indicating of gaze tracking, and combining a plurality of gaze tracking outcomes to obtain a main gaze tracking.

Optionally, the processing circuitry is further configured for assigning weights to each of the plurality of gaze tracking, wherein imaging sensors directly aimed at the gaze are assigned relatively higher weights, wherein the combination is computed using the weights.

Optionally, the processing circuitry is further configured for dynamically computing the main gaze tracking for each set of the plurality of compromised quality datasets obtained in real time, and providing the dynamically computed main gaze tracking as input into another executing process for controlling visual elements presented on the display.

Optionally, the dynamically computed main gaze tracking is provided via an application programming interface (API).

Optionally, analyzing comprises feeding a sequence of a plurality of sets of compromised quality datasets into a machine learning model that generates an outcome of a recognized gesture, wherein the dataset comprises the recognized gesture.

Optionally, the machine learning model is trained on a training dataset comprising a plurality of records, each record including a sequence of a plurality of compromised quality datasets obtained from the plurality of imaging sensors of a respective sample individual, labelled with a ground truth gesture.

Optionally, analyzing comprises computing a N-D signature indicating a biometric identified of a user from a time sequence of a plurality of main images generated from a time sequence of a plurality of sets of compromised quality datasets, wherein the dataset includes temporal data and implicit unique features indicative of at least one of: habits and behavior of the user, identification of the user, actions performed by the user, history of the user, track of the user, gesture performed by the user, gaze of the user, main images and main audio signals, depth information, segmentation, and classification data.

In some embodiments, a display monitor comprises: a screen comprising an array of pixels, a plurality of audio sensors arranged in a grid located within the array of pixels and/or behind and/or within the screen, the plurality of audio sensors being spaced part and distributed across a width and length of the screen, wherein a plurality of pixels are disposed between spaced apart audio sensors, each audio sensor adapted for outputting a degraded signal including distorted pitches, and circuitry integrated within the display monitor, the circuitry is configured for obtaining the degraded signals outputted by the plurality of audio sensors, combining the plurality of degraded signals into a main audio signal with high fidelity, and providing the main audio signal.

Optionally, for each respective audio sensor, a size of a membrane responding to sound waves is less than about 250 micrometers.

Optionally, the circuitry is further configured for computing a directionality of a sound source by analyzing the plurality of degraded signals form the plurality of audio sensor.

Optionally, analyzing comprises enhancing audio signals of each respective audio sensor based on a combination of audio signals from other audio sensors, estimating principal vectors of sound cones from changes in amplitude and phase between audio signals of the respective audio sensor and the other audio sensors, and computing the directionality of the sound source by computing a sound vector for each respective audio signal, and computing an intersection of a plurality of sound vectors, wherein the intersection denotes location of the sound source.

Optionally, the circuitry is further configured for differentiating between a plurality of different sources by analyzing the plurality of degraded signals form the plurality of audio sensor.

Optionally, the circuitry is further configured for regaining an amplitude of the main audio signal by a summation of amplitudes of corresponding frequencies, wherein weak frequencies that are too weak to reach some audio sensors are recovered from other audio sensors that did pick up the weak frequencies, and combining phase and angular differences between audio sensors to obtain a full spectrum of the original sound wave in the main audio signal.

In some embodiments, an apparatus for generating images, comprises: at least one hardware processor configured for: (i) analyzing a plurality of compromised quality datasets obtained by a plurality of imaging sensors arranged in a first grid located behind and/or within a screen of an array of pixels, the plurality of imaging sensors being spaced part and distributed across a width and length of the screen, wherein a plurality of pixels are disposed between spaced apart imaging sensors, each imaging sensor sized and adapted for outputting a respective compromised quality dataset depicting a partial field of view, wherein the screen comprises a plurality of pinholes corresponding to the location of the plurality of imaging sensors arranged in the grid, wherein each single pinhole corresponds to each single imaging sensor, (ii) analyzing a plurality of sub-audio signals obtained by a plurality of audio sensors arranged in a second grid located behind and/or within the screen, the plurality of audio sensors being spaced part and distributed across a width and length of the screen, wherein a plurality of pixels are disposed between spaced apart audio sensors, wherein each sub-audio signal outputted by each audio sensor is a degraded signal including distorted pitches, (iii) analyzing a main image stitched from the plurality of compromised quality datasets, the main image is at a higher resolution and depicts a full field of view relative to the compromised quality datasets, wherein the SNR of the main image is higher than the SNR of the compromised quality datasets, (iv) analyze a main audio signal with high fidelity generated by combining the plurality of sub-audio signals, and (v) generating a dataset for providing to another executing processor by iterating (i)-(iv) for a plurality of time sequence sets denoting a plurality of epochs of compromised quality datasets and sub-audio signals.

Optionally, the dataset is provided to another executing processor for controlling visual elements presented on the display by the iterating of (i)-(iv).

Optionally, the dataset is provided via a member selected from a group consisting of: application programming interface (API), software development kit (SDK), and virtual interface.

Optionally, the processor is further configured for detection and segmenting dynamic portions of a scene depicted in the main image, wherein at each epoch, data of previous frames' separation is combined with a change detection process run on each image sensor separately and with depth estimation computed for each compromised quality dataset.

Optionally, the processor is further configured for computing a respective dataset per epoch, the dataset including one or more members selected from a group consisting of: habits and behavior of objects, names of objects, and actions performed by objects, history per object, track per object, gesture performed by subjects, gaze of subjects, main images and main audio signals, depth information, segmentation, and classification data.

Optionally, the processor is further configured for generating a customized training dataset of a plurality of dataset each labelled with a ground truth interaction of the specific user, and training a customized machine learning model for recognizing interactions of the specific user on the customized training dataset, wherein the interaction is selected from a group consisting of: pose, gaze, gesture, audio sounds, and combination of audio sounds and pose and/or gaze and/or gesture.

Optionally, the processor is further configured to compute a plurality of hierarchical data elements from the data, and to provide selected hierarchical data elements based on a permission parameter.

Optionally, the processor is further configured to compute a N-D signature indicating a biometric identifier of a user from a time sequence of a plurality of main images and a plurality of main audio signals, wherein the dataset includes temporal data and implicit unique features indicative of at least one of: sounds of the user, habits and behavior of the user, identification of the user, actions performed by the user, history of the user, track of the user, gesture performed by the user, gaze of the user, main images and main audio signals, depth information, segmentation, and classification data.

In some embodiments, a display monitor comprises: a screen comprising an array of pixels, a plurality of audio speakers arranged in a grid located within the array of pixels and/or behind and/or within the screen, the plurality of audio speakers being spaced part and distributed across a width and length of the screen, wherein a plurality of pixels are disposed between spaced apart audio speakers, each audio speaker adapted for outputting a degraded signal including distorted pitches, and circuitry integrated within the display monitor, the circuitry is configured for controlling the plurality of audio speakers to generate a high-fidelity sound with selected directionality.

Referring now back to FIG. 10B, a flowchart of another exemplary approach for an immersive experienced without headset is provided. Features described with reference to FIG. 10B may be based on, and/or include, one or more features described with reference to FIG. 2.

It is noted that the features described with FIG. 10B are different than the features described with reference to FIG. 10A, in that in FIG. 10B, the local user and/or remote object are tracked. This is in contrast to the features described with reference to FIG. 10A, in which motion of the user across the display (i.e., the common surface) is dynamically tracked to identify a new location of the user on the display (i.e., the common surface). Tracking motion of the user across the display, as described with reference to FIG. 10A, may be fairly simple to compute, and/or may be computationally efficient, for example, by analyzing the images on the display. This is in contrast to monitoring the user themselves and/or the object, as described with reference to FIG. 10B, which may be more complex to perform and/or may require additional computational resources.

The following features may iterated in at least one iteration. The object (e.g., first participant in a conference, and/or an inanimate object) is tracked, optionally by the sensor array that captures images of the object. The tracking may be of the pose and/or location of the object. A different virtual sensor is defined at another location of the sensor array according to the dynamic tracking of the object. For example, when the object is a participant in a conference call, the participant moves to their left from a position approximately in the middle of the sensor array, the virtual sensor location is moved from the middle of the sensor array to the right side of the sensor array. A different virtual sensor dataset is computed for the different virtual sensor, for example, the different virtual sensor dataset is for the virtual sensor on the right, changed from the virtual sensor in the middle. A stream of the different virtual sensor dataset is streamed to the client terminal. The iterations dynamically track the object, and dynamically select the location of the virtual sensor for maintaining the object in the stream sent to the client terminal.

Alternatively or additionally, the following features are iterated in at least one iteration. A user views a stream on a display of a client terminal, the stream depicting an object according to a virtual sensor dataset of the defined virtual sensor. The user is tracked, for example, the pose and/or location of the user is tracked. A different virtual sensor is defined at another location of the sensor array according to the dynamic tracking of the user. For example, when the user moves to their left from a position approximately in the middle of the sensor array, the virtual sensor location is moved from the middle of the sensor array to the right side of the sensor array. The user may move from the middle to the left, for example, to have a closer look at an object located to the left. A different virtual sensor dataset is computed for the different virtual sensor, for example, the different virtual sensor dataset is for the virtual sensor on the right, changed from the virtual sensor in the middle. A stream of the different virtual sensor dataset is streamed to the client terminal. The iterations dynamically track the user, and dynamically select the location of the virtual sensor for generating a virtual experience for the user viewing the stream on the display of the client terminal.

At least some of the displays, devices, systems, methods, and code instructions described herein provide a solution to the aforementioned technical problem, and/or improve the aforementioned technical field, and/or improve upon aforementioned approaches, by defining a virtual sensor on a sensor array disposed on a common surface. Sensor datasets of the sensor array captured from different views are analyzed, optionally by feeding the sensor datasets into a GAN. A virtual sensor dataset is computed for the virtual sensor according to the analysis, for example, as an outcome of the GAN. A stream of the virtual sensor dataset is directed to a client terminal. The location on the sensor array that defines the virtual sensor may be dynamically adapted, for providing a dynamic virtual immersive experience using the stream of the virtual sensor presented on the display of the client terminal. The location that defines the virtual sensor may be dynamically adapted based on changing location and/or changing pose of the user viewing the stream and/or based on changing location and/or changing pose of the object which is being depicted in the stream.

At 1002, a virtual sensor(s) is defined on a sensor array located on a common surface, for example, as described with reference to 206 of FIG. 2.

The common surface referred to herein as being located in a remote location. The sensor array on the common surface at the remote location captures images of an object, for example, a human participant (e.g., reference to herein as the first participant) in a conference call, a living animal being viewed, and/or an inanimate object (e.g., car, furniture, and the like).

At 1004, sensor datasets of the sensor array captures from different views are analyzed, for example, as described with reference to 208 of FIG. 2. The sensor datasets may be analyzed by feeding to a trained ML model, optionally a GAN, as described herein. The sensor dataset are obtained by the remote sensor array.

At 1006, a virtual sensor dataset for the virtual sensor is computed, for example, as described with reference to 210 of FIG. 2. Optionally, the virtual sensor dataset is obtained as an outcome of the trained ML model, optionally the GAN. The virtual sensor dataset is for the location of the virtual sensor

At 1008, a stream of the virtual sensor dataset is directed to a client terminal, optionally of a user (e.g., referred to herein as the second participant), for example, as described with reference to 216 of FIG. 2. The client terminal is referred to herein as being located locally. The stream of the virtual sensor dataset is directed to a local client terminal.

The client terminal may be associated with a display. The display may include its own sensor array, which captures images which are used to define a virtual sensor and send the virtual sensor dataset to another client terminal, such as the client terminal for which the virtual sensor is defined as in 1002.

At 1010, the virtual sensor dataset is presented on a display of the client terminal, for example, as described with reference to 218 of FIG. 2. The remotely defined virtual sensor dataset is presented on the display of the local client terminal.

Features 1012B-1018B relate to an optional implementation in which a remote object is being tracked. For example, for dynamically selecting the virtual sensor for maintaining a substantially constant target pose of the object that is directed in the stream to the local client terminal.

At 1012B, the remotely located object is dynamically tracked. The tracking may be done, for example, based on the sensor dataset of the real sensors of the sensor array, and/or using other remotely located sensors.

The remote object may be tracked, for example, to determine changes in pose, such as change in location and/or orientation. For example, when the remote object is the first participant, to track whether the first participant turned their body to face more to the left or more to the right. In another example, the remote object is tracked to identify whether the remote object moved closer to the sensor array, or further back away from the sensor array.

The tracking may be done, for example, by image processing approaches and/or ML approaches. For example, identifying features on the object in images, and comparing changes in the location and/or pattern of the features of current images to preceding images. For example, using optical flow to determine whether the change in location of the features represents side movement of the object, rotation of the object, and/or forward/backward movement of the object. In another example, using ML models to identify when a participant is facing forward, and when the participant has turned, determining where the participant is now facing in order to be able to select another virtual sensor to continue depicting the participant facing forward.

At 1014B, a different virtual sensor at another location of the sensor array is defined according to the dynamic tracking of the object. For example, when the object turns to the right (from the perspective of the common surface of the sensor array), and/or moves to the right, from a current location facing forward and/or in the middle, a different virtual sensor on the right of the common surface may be dynamically selected. Alternatively or additionally, the different virtual sensor represents a zoom-in on the object, and/or a zoom-out of the object. For example, when the object moves back away from the common surface of the sensor array, the different virtual sensor represents a zoom-in on the object to maintain a substantially constant size of the object in the created and/or presented virtual sensor dataset.

At 1016B, a stream of the different virtual sensor dataset is computed and directed to the client terminal, for example, for local presentation on a display.

At 1018B, features described with reference to 1012B-1016B are iterated, to provide real-time or near real-time dynamic adaptation according to the tracked object, for example, to maintain a substantially constant view of a target pose of the object. For example, when the object is a speaker, to maintain a face-on view of the speaker, regardless of whether the speaker moves forward, backwards, sideways, or rotates their body to the side.

Alternatively or additionally, features 1020B-1026B relate to an optional implementation in which the local user is being tracked. For example, for dynamically selecting the virtual sensor according to the local user, such as to provide different views of the object according to the pose of the local user.

At 1020B, the local user is dynamically tracked. The tracking may be done, for example, based on the sensor dataset of the real sensors of the sensor array of the display of the local client terminal, and/or using other local sensors.

The local user may be tracked, for example, to determine changes in pose, such as change in location and/or orientation. For example, to track whether the user moved to the left, to the right, closer to the screen, or further away from the screen.

In another example, the local user may be tracked to identify predefined gestures, for example, hand movements indicating how to shift the virtual sensor, such as moving the hand to the left indicating to shift the virtual sensor to the left, and/or a hand clapping motion indicating a zoom, and the like.

The tracking may be done, for example, by image processing approaches and/or ML approaches. For example, identifying features on the user in images, and comparing changes in the location and/or pattern of the features of current images to preceding images. For example, using optical flow to determine whether the change in location of the features represents side movement of the user, rotation of the body of the user, and/or forward/backward movement of the user. In another example, using ML models to identify when the user is facing forward, and when the user has turned, determining where the user is now facing.

At 1022B, a different virtual sensor at another location of the remote sensor array depicting the remote scene is defined according to the dynamic tracking of the user. For example, when the user turns to the right from the perspective of the local display, and/or moves to the right, from a current location facing forward and/or in the middle, a different virtual sensor on the right of the remotely located common surface may be dynamically selected.

Alternatively or additionally, the different virtual sensor represents a zoom-in on the object, and/or a zoom-out of the object. For example, when the user moves closer to the local display, another virtual sensor at the remote location representing a zoom-in on the remote scene is selected.

At 1024B, a stream of the different virtual sensor dataset depicting the remote scene is computed and directed to the local client terminal, for example, for local presentation on a display.

At 1026B, features described with reference to 1020B-1024B are iterated, to provide real-time or near real-time dynamic adaptation according to the tracked user, for example, to dynamically adapt the remote scene according to how the user is locally positioned. For example, when the local user is viewing a remote object, the user may move to the left to dynamically view the remote object from the left, then move closer to the local display to dynamically view a zoom-in of the remote object. This provides an immersive experience without headset.

Additional exemplary embodiments, for example based on FIG. 10B, are now described:

Optionally, the virtual sensor is selected for depicting an object for presentation on a display of the client terminal, and further comprising: in at least one iteration: dynamically tracking the object, dynamically defining a different virtual sensor at another location of the sensor array according to the dynamic tracking of the object, wherein computing the virtual sensor dataset comprises computing a different virtual sensor dataset for the different virtual sensor, and directing a stream of the different virtual sensor dataset to the client terminal.

Optionally, dynamically tracking comprises dynamically tracking a current pose of the object relative to a target pose, defining the different virtual sensor for depicting the object at the target pose, wherein the stream of the different virtual sensor dataset depicts the object at the target pose.

Optionally, the virtual sensor is selected according to a pose of a user viewing the stream on a display of the client terminal, and further comprising: in at least one iteration: dynamically tracking the pose of the user, dynamically defining a different virtual sensor at another location of the sensor array according to the dynamic tracking of the user, wherein computing the virtual sensor dataset comprises computing a different virtual sensor dataset for the different virtual sensor, and directing a stream of the different virtual sensor dataset to the client terminal.

Optionally, the pose of the user is tracked to determine a location of the user towards a display of the client terminal presenting the stream, wherein dynamically tracking the pose comprises dynamically tracking the location of the user and dynamically defining the different virtual sensor at another location that corresponds to the location of the second participant.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant sensors will be developed and the scope of the term sensor is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A computer implemented method of virtualization of one or more sensors, comprising:
defining a location of a virtual sensor on a sensor array disposed on a common surface;
analyzing a plurality of sensor datasets of the sensor array captured from a plurality of different views;
computing a virtual sensor dataset for the location of the virtual sensor according to the analysis; and
directing a stream of the virtual sensor dataset to a client terminal.

2. The computer implemented method of claim 1, wherein the common surface comprises a display, and further comprising:
presenting an image of a user on the display;
in at least one iteration:
dynamically tracking motion of the user across the display to identify a new location of the user on the display;
dynamically selecting a new location of the virtual sensor on the display according to the new location of the user on the display;
computing the virtual sensor dataset for the new location of the virtual sensor; and
directing the stream of the virtual sensor dataset to the client terminal.

3. The computer implemented method of claim 2, wherein dynamically tracking motion of the user across the display comprises analyzing an image depicting the user on the display to identify motion of the user within the image.

4. The computer implemented method of claim 2, wherein the image of the user is presented within a window on the display, and dynamically tracking motion of the user across the display comprises tracking change of location of the window on the display.

5. The computer implemented method of claim 2, wherein the image of the user presented on the display is captured by a camera remotely located in proximity to the client terminal and in proximity to the user, wherein the user is viewing the client terminal while the camera is capturing images of the user.

6. The computer implemented method of claim 5, wherein the camera is selected from: another virtual sensor located on another common surface created from another sensor array capturing images of the user, and a standard camera capturing a video.

7. (canceled)

8. The computer implemented method of claim 1, wherein the virtualization of the one or more sensors is for interactions between participants participating in a virtual conference, wherein the virtual sensor is selected for generating a single face-on view of a first participant as seen remotely by at least one second participant participating in a conference, wherein the plurality of sensor datasets of the sensor array capture the first participant from the plurality of different views, and wherein the client terminal is of the at least one second participant, for depicting a single face-on view of the first participant as viewed from the virtual sensor by the second participant.

9. The computer implemented method of claim 8, wherein a plurality of participants are participating in the conference, wherein the plurality of participants include the first participant associated with a certain sensor array, and a plurality of second participants remotely interacting with the first participant via the conference,
for the plurality of participants:
defining comprises defining a plurality of virtual sensors, each one of the plurality of virtual sensors representing a respective face-on view from one of the plurality of second participants viewing the first participant;
computing comprises computing a plurality of virtual sensor datasets for the plurality of virtual sensors according to the analysis; and
feeding comprises feeding a plurality of streams of the plurality of virtual sensor datasets from the sensor array of the first participant to the plurality of sensor arrays of the plurality of second participants.

10-13. (canceled)

14. The computer implemented method of claim 1, wherein analyzing comprises feeding the plurality of sensor datasets into a virtualization machine learning model that generates the virtual sensor dataset as an outcome thereof.

15. The computer implemented method of claim 14, wherein the virtualization machine learning model comprises a generative adversarial network comprising a generator component and a discriminator component,
wherein the generator component generates an outcome of virtual sensor dataset corresponding to a virtual sensor in response to an input of a plurality of sensor datasets captured by a plurality of sensors,
wherein the generating component is adapted during training on feedback from the discriminator component for generating virtual sensor datasets that the discriminator component cannot accurately distinguish from ground truth datasets captured by a ground truth sensor.

16. The computer implemented method of claim 15, wherein the generator component is trained on a training dataset of a plurality of records, each record including a plurality of sample sensor datasets depicting a plurality of different views, and a ground truth dataset depicting a ground truth view of a ground truth sensor representing the virtual sensor.

17-20. (canceled)

21. The computer implemented method of claim 1, wherein each sensor of the sensor array is configured for outputting a compromised quality dataset depicting a partial field of view, and computing the virtual sensor dataset comprises stitching a plurality of compromised quality datasets into a main dataset at higher quality that depicts a full field of view.

22. The computer implemented method of claim 21, wherein computing comprises feeding the plurality of compromised quality datasets into a stitching ML model that generates the main dataset as an outcome thereof, the stitching ML model trained on a stitching training dataset comprising a plurality of records, each record including a sample of a plurality of compromised quality datasets and a ground truth main dataset obtained from at least one of: a high quality sensor and a synthesized dataset.

23. The computer implemented method of claim 22, wherein each compromised quality dataset of each sensor is fed an autoencoder that extracts an encoding, a plurality of the encodings are of a plurality of the autoencoders are fed into the stitching ML model, wherein the stitching ML model and the plurality of autoencoders are jointly trained end to end.

24. The computer implemented method of claim 1, wherein the virtual sensor dataset includes a depth map indicating a respective depth for each data element of the virtual sensor dataset relative to a normal at a location of the virtual sensor.

25. The computer implemented method of claim 24, wherein the depth map is computed by feeding the plurality of sensor datasets into a depth ML model trained on a depth training dataset comprising a plurality of records, each record including a plurality of sample sensor datasets and a ground truth of a sample depth map.

26. The computer implemented method of claim 25, wherein at least one record includes a plurality of sample sensor datasets and the ground truth produced synthetically from a 3D simulation.

27. The computer implemented method of claim 24, further comprising:
merging the plurality of sensor datasets into a lattice in which each sensor dataset is positioned based on location in space of the corresponding sensor, wherein the lattice represents a single dataset in which relative location of each sensor is defined; and
converting a plurality of positions of the lattice into indications of depth relative to the virtual sensor for computing the depth map for the virtual sensor dataset.

28. The computer implemented method of claim 1, wherein the sensor array comprises a plurality of sensors selected from a group comprising imaging sensors and audio sensors.

29. A system for virtualization of one or more sensors for interactions between participants participating in a virtual conference, comprising:
at least one processor executing a code for:
defining a virtual sensor on a sensor array disposed on a common surface;
analyzing a plurality of sensor datasets of the sensor array captured from a plurality of different views;
computing a virtual sensor dataset for the virtual sensor according to the analysis; and
directing a stream of the virtual sensor dataset to a client terminal.

30-31. (canceled)
